(19) United States
(12) Patent Application Publication
(10) Pub. No.: US 2026/0111828 A1
(43) Pub. Date: Apr. 23, 2026

(54) SYSTEM FOR AUTOMATED DETECTION AND ASSESSMENT OF EMPLOYEE-BASED ELECTRONIC LINKS OF A UNIT TO EXTERNAL ACTORS, AND ELECTRONIC METHOD THEREOF

(71) Applicant: Swiss Reinsurance Company Ltd., Zürich (CH)

(72) Inventors: Tobias MAEDER, Zürich (CH); Prasad NAIK, Zürich (CH)

(73) Assignee: Swiss Reinsurance Company Ltd., Zürich (CH)

(21) Appl. No.: 19/329,139

(22) Filed: Sep. 15, 2025

Related U.S. Application Data
(63) Continuation of application No. PCT/EP2025/051024, filed on Jan. 16, 2025.

(30) Foreign Application Priority Data
Jan. 18, 2024 (CH) CH000061/2024

(51) Int. Cl. G06Q 10/0639; G06Q 10/107

(52) U.S. Cl. CPC G06Q 10/06398; G06Q 10/107

(57) ABSTRACT

An electronic system and method for automated detection and assessment of employee-based electronic links of at least one employee to external actors interacting with the at least one unit is based on automated interaction data mining and impact weighting of the employee-based electronic links. A trigger module with a plurality of capturing devices connectable to at least one employee automatically captures employee data comprising employee-based parameter values for one or more employee-based parameters identifying at least one electronic employee account associated to the at least one employee and link data comprising interaction parameter values for one or more interaction parameters characterizing electronic interactions. A link network module for data mining and transfer control is connected to the trigger module and a trigger table. The link network module comprises an accumulation device connected to the trigger module, which automatically receives the employee data and the link data. The accumulation device comprises a data extraction algorithm extracting external actor data comprising actor parameter values of actor parameters included in the link data, and stores the employee data, the link data and the external actor data in a repository unit. A weighting unit comprises a weighting algorithm automatically assigning weighting factors to one or more of the captured interaction parameter values and/or to the employee-based electronic link and provides weighted link data for the employee-based electronic links. The trigger table comprises parameter filters for selecting specific employee parameter values and/or interaction parameter values, and a network modelling algorithm modelling the employee-based electronic links associated with the selected specific parameters according to their weighting factor as the output electronic link network.

### CROSS REFERENCE TO RELATED APPLICATIONS

The present application is a continuation application of International Patent Application No. PCT/EP2025/051024, filed Jan. 16, 2025, which is based upon and claims the benefits of priority to Swiss Application No. 000061/2024, filed Jan. 18, 2024. The entire contents of all of the above applications are incorporated herein by reference.

### FIELD OF THE INVENTION

The present invention relates to a system for automated detection and assessment of employee-based electronic links of a unit to external actors, particular corporate actors, on the unit, particularly a system for automated detection and assessment of employee-based electronic links representing customer relationships and providing an electronic customer network, and more specifically a customer relationship management (CRM) system for automated detection and assessment of employee-based electronic links of the unit to external customers, and more specifically to automated customer interaction data mining for a CRM system.

### BACKGROUND OF THE INVENTION

For companies it has become increasingly important to enhance the experience for customers interacting with the company. For example, the circumstance of losing a customer, can be very costly, as it may be many times more expensive to acquire a new customer than to keep an existing one. Thus, companies are seeking ways to retain customers by offering a superior experience, while delivering unique experiences to different customer segments. Customer Relationship Management (CRM) involves managing interactions with existing and potential customers. CRM helps manage streamline processes, build customer relationships, increase sales, improve customer service, and increase profitability. In many industries, a relatively small percentage of customers represents a majority of a company's revenue, so a company will focus attention to the experience offered to high-value customer segments to enhance profitability. Customers today are empowered with information, and they evaluate their relationship with a company with respect to their own unique needs. However, companies often lack a rich set of data about customer behavior and insights. Without a way to collect a robust set of customer data and intelligent data assessment, a company may be inclined to monitor only what is easy to measure and will usually not develop deep insights derived from customer interactions.

Modern CRM systems use a combination of practices, strategies and technologies to manage and analyze customer interactions and data throughout the customer lifecycle. CRM systems compile customer data across different channels and points of contact between the customer and the company. These can include the company's website, telephone, live chat, direct mail and marketing materials. CRM systems give customer-facing employees detailed data on customers' personal information, purchase history, buying preferences and concerns. Furthermore, CRM systems as for example Salesforce, comprise artificial intelligence (AI) capabilities for automation of work tasks and streamlining workflows. Machine learning and natural language processing are the two most used AI techniques which support predictive analysis and help in marketing, sales, services, and other business segments. For example, it may be forecasted which customer is more likely to buy a product, hence providing a lead on the potential customers. Artificial intelligence methods are also used to increase the rate of conversion of a potential buyer to a customer for example by predicting an engagement score, or to improve an advertising experience for a user by predicting advertising formats that are most likely to get recognized by the user. US 2021/0174372 A1 for example discloses a CRM software platform that interfaces with an AI entity. Nevertheless, CRM systems are mostly customer focused and do not show or analyze interactions between customers or their companies. Nor are they able to reflect or predict networks or network trends of a plurality of customers, companies, or other stakeholders in a business interaction. Social network platforms are also not suited for analyzing business to business (B2B) or business to customer (B2C) exchange and for understanding a company's relationships with their external stakeholders. Taking LinkedIn social media platform as an example, the connections between individuals don't represent the company but rather the individual's relationships and interaction data are proprietary to their subscribers.

The prior art document US 2012/102126 A1 shows a system and method of generating relationship data by performing the following steps: (i) accessing an interaction database, wherein the interaction database comprises a record of exchanges between a plurality of users of a digital communication system, and wherein the exchanges occurred on the digital communication system: (ii) obtaining characteristics of exchanges of the users, wherein the characteristics are stored in the interaction database and wherein the data is obtained through a direct internet access protocol; and (iii) generating relationship data by analyzing the characteristics. The characteristics comprise interaction volume, interaction frequency, interaction type, number of communication participants, the time since the first interaction, and the time since the last interaction. US 2020/0372016 A1 shows a system providing content items, which is enabled to generate the content items based on impact scores associated with actions of the content items. The system comprises the steps of (i) accessing, for an entity, record objects linked with electronic activities having the entity as a participant, each record object corresponding to an event to be completed: (ii) identifying, for each of the record objects, an action to perform to increase a completion score: (iii) determining, for each action, using the electronic activities linked with the record object and a current completion score of the record object, an impact score indicating an amount of change in the completion score of the record object corresponding to the action; and (iv) providing, for presentation to a device of the entity, a content item corresponding to the action based on the impact score. Finally, U.S. Pat. No. 11,108,580 B2 shows a machine-learning based method for improving a collaboration environment. The method comprises the steps of (i) receiving text data for one or more users of the collaboration environment. (ii) generating a statement by partitioning the text data, (iii) determining an act using the statement and generating a thread using at least the state-ment and the act, (iv) generating an actor list using at least the thread, and (iv) generating an actionable item using the actor list and the thread.

### Description of the Invention and Description of the Drawings

It is one object of the present invention to provide an electronic system and method for automated detection and assessment of individual employee's links, connections or wickerwork of an employee to external actors and an automated interaction data mining apparatus trigger based on employee-based electronic links of the employee.

Particularly, it is an object of the present invention to provide an electronic system and method for automated detection and impact weighting of employee-based electronic links for building a link network structure and deriving an electronic link network representing a customer relationship network. More specific, the electronic system and method shall be able to transform relationship information into a qualified customer network, extract and reflect topics and trends discussed within the customer network, act as distribution mechanism sharing customer information across employees, extract and distribute customer insights along a dynamic relationship network and automatically update the link network and incorporate insights of discussion subjects into a network presentation. Especially, the electronic system and method shall be flexibly adaptable to differing assessment emphasis, easily configurable to react to changing characteristics of customer relationships, simple to be integrated in existing customer relationship management systems, and able to provide a current relationship network presentation in real-time. Preferably, the electronic system and method for automated detection and assessment should be accessible via: (i) Network Flagship Applications (Explorer/Firefox, Safari, Chrome, etc.), (ii) Micro-Front End (Email Plugin), and (iii) API Data Service.

An electronic system and an electronic method for automated detection and assessment of employee-based electronic links of at least one employee to external actors interacting with the employee according to the invention is based on automated interaction data mining and impact weighting of the employee-based electronic links. The at least one employee of the electronic system can, for example, be associated with a network-enabled device (or uniquely identifiable account or electronic employee identification) capable of transmitting data in a digital network like a computer, a laptop, a smartphone or a similar computing device, which for example runs an application identifying an employee of a company by detecting credentials of an electronic employee account associated with the employee using the electronic employee identification. It is to be noted, the interaction metadata is extracted from communication via email clients like Outlook, etc. The present inventive system is typically not detecting credentials of an electronic employee identification like the IP address. The inventive system extracts email metadata, e.g. hans_muster@firm.com is communicating with email address johndhoo@ltdcorp.com and extracting metadata from MIME Multipurpose Internet Mail Extensions (MIME) is a standard that extends the format of email messages to support text in character sets other than ASCII, as well as attachments of audio, video, images, and application programs. Message bodies may consist of multiple parts, and header information may be specified in non-ASCII character sets. Email messages with MIME formatting are typically transmitted with standard protocols, such as the Simple Mail Transfer Protocol (SMTP), the Post Office Protocol (POP), and the Internet Message Access Protocol (IMAP), i.e., MIME metadata without email content or subject.

The external actors may be corporative actors, like customers, suppliers or contractors of the company, employees of other companies, representatives of organizations, etc. The external actors interact with the at least one employee identifiable by the electronic employee identification of the electronic system for example by using an external network-enabled unit, such as a computer, a laptop, a smartphone or a similar computing device. The employee's unit or network node of the electronic system and the external actors using external units or network nodes for example run applications for data exchange and generate electronic interactions between the employees and external actors, as commonly known. The employee-based electronic link may be defined by just one electronic interaction or by a plurality of electronic interactions of an employee with one external actor or external unit of an external actor, respectively. It is to be noted, that the interaction will typically always be with an employee of one external actor e.g. johndhoo@ltdcorp, where in this example, ltdcorp is the unit of an external actor i.e. the domain and respectively the company. The electronic system and method of the invention is able to extract a weighted electronic link network of a plurality of employee-based electronic links reflecting a link strength and/or link intensity within the electronic link network. As such, the electronic link network in a technical way reflects a real-world relationship network between employees of a company and external customer, companies and other players.

According to the invention the electronic system comprises a trigger module with a plurality of capturing devices connected or connectable to at least one unit for automatically capturing employee data comprising employee-based parameter values for one or more employee-based parameters identifying at least one electronic employee account associated to the at least one unit, and for capturing link data comprising interaction parameter values for one or more interaction parameters characterizing interactions of the employee-based electronic links. That means, the employee data and the link data include employee-based parameter values, respectively parameter values, which are detected by scanning a data exchange between the employee and the external actor, using the capturing devices. It is to be noted that rather email metadata MIME standard are extracted than scanning data exchange. It is to be kept in mind, that the inventive system typically has no access to subject or email content simply metadata. For example, the capturing devices are linked to the employee or an incoming data channel of the employee. More than one employee-based parameter values together create an employee data set that for example characterizes the electronic employee account. The link data includes at least one interaction parameter value that characterizes a data exchange interaction between the unit of the employee and the external actor. The one or more interaction parameters of the link data include one or more actor parameters characterizing the external actor that is interacting with the unit and/or network node of the employee of the electronic system and establishes an employee-based electronic link by this interaction. More than one interaction parameter values together create a link data set characterizing the data exchange of the interactions of the employee-based electronic link. The capturing devices may be connected to the units of the employees for example by a digital network, like the internet, as commonly known. However, the interaction mining is based on MIME metadata through email messaging only, no internet data crawling. The trigger module serves as a data collection entity of a data mining process of the electronic system and method. The captured employee data and link data define input data that is automatically retrieved for the automated interaction data mining and impact weighting process of the electronic method according to the invention.

Further, the electronic system comprises a link network module for data mining and transfer control connected to the trigger module and a trigger table providing the electronic link network based on selected employee parameters and/or selected interaction parameters. The link network module at least comprises or is connectable to an accumulation device connected to the trigger module and to a repository unit. The link network module, respectively the accumulation device, automatically receives the employee data and the link data as input data. The accumulation device comprises a data extraction algorithm identifying and extracting external actor data comprising actor parameter values of actor parameters included in the link data. The external actor data identifies the external actor, respectively the external actor unit or actor account used by the external actor, that is subject of the interaction with the unit of the electronic system. The actor data for example serves as a contact record defining the actor as a contact of the employee, respectively the employee account. The accumulation device may serve as a data integration or data preparation entity of the electronic system and method according to the invention. The accumulation device stores the employee data, the link data and the external actor data in the repository unit. The repository unit serves as a storage structure for storing and organizing the data processed by the electronic system. The repository unit may be a decentralized unit like a cloud based storage structure. For example, the repository unit is a data lake or data warehouse.

Further, the link network module comprises a weighting unit connected to the accumulation device and/or the repository unit and comprising a weighting algorithm automatically assigning weighting factors to one or more of the captured interaction parameters and/or to the employee-based electronic link, and providing weighted link data for the employee-based electronic links. A weighting factor correlates to a link strength, respectively link intensity or importance, related to the one or more parameter values of the interaction parameter and/or the employee-based electronic link, i.e. the weighting factor correlates to the contribution of an interaction to the overall employee-based electronic link, and therefor to the contribution of employee-based electronic link to the overall electronic link network. The link strength, respectively the weighting factor, for example may be determined by measuring characteristics and/or attributes of the employee, the interactions, the employee-based electronic link and/or the external actor. The weighting algorithm serves the technical purpose of determining a quantified contribution of an employee-based electronic link to an electronic link network including this link. For example, the weighting algorithm automatically measures an interaction frequency, an interaction number, an interaction time or time range, an interaction classification, a type of the interactions or similar quantifiable features, wherein for example a high frequency, large number, high classification, etc. may indicate a strong link strength and a low frequency, small number, low classification, etc. may indicate a weak link strength. Accordingly, the corresponding weighting factor is higher in the first case and lower in the second case. On a scale from 0-1, the weakest weighting factor equals to 0 gradually increasing to the strongest weighting factor that equals to 1. The weighted link data for example serves as the basis for an enriched contact record, which includes the contact record defined by the actor data and insights about the quality of the employee-based electronic link with this external actor indicated by the weighted interaction parameter values. The weighted link data may be provided to the accumulation device or to the repository unit. The weighting unit may serve as a data mining entity of the electronic method according to the invention.

The trigger table is connected or connectable to the accumulation device or the repository unit of the link network module. It provides the electronic link network based on selected employee parameters and/or selected interaction parameters. The trigger table comprises parameter filters for selecting specific employee parameter values and/or interaction parameter values by a user of the electronic system. A specific parameter is selected according to individual interests in a relationship network of a specific employee or actor or an actor group. Further, the trigger table comprises a network modelling algorithm, which models the employee-based electronic links associated with the selected specific parameters according to their weighting factor as the output electronic link network. The trigger table summarizes all employee-based electronic links of the selected specific parameters and presents the link strength of the employee-based electronic links according to their weighting factor. The network modelling algorithm transfers the weighted link data into a network presentation illustrating the relationships of the unit, employee or employee group with external actors or actor groups. The network modelling algorithm for example is realized as a flow algorithm, optimizing algorithm, clustering algorithm, community detection algorithm, or simulation algorithm. The trigger table may serve as an interpretation and deployment entity of the electronic method according to the invention.

Selecting specific employee parameters and/or interaction parameters triggers the link network module to capture employee data, link data and extract actor data, and to measure the weighting factors for the weighted link data as the basis for the network modelling algorithm, which outputs the modelled output electronic link network representing a quantified, respectively weighted, actor relationship network. Thus, the electronic system and method of the invention transform a dynamic real-world social interaction network into a technically quantifiable electronic link network, which is provided by the automatically generated output electronic link network for a specific employee, external actor, or company.

The electronic system and method of the invention have the advantages that they allow to analyze a large number of data exchanges amongst different users or groups of users, i.e. employees and/or employees' units, with external actors while there may or may not be an already registered contact record for an external actor, and assess the linking of the users and external actors in the context of other users and external actors. Thereby, the invention allows to provide a data-based representation of dynamic customer relations within a wide circle of users and user groups, which is not possible in existing prior art relationship management systems. Further, it allows to automatically provide qualified and updated information about individual relationship links for each user in real-time with added information insights. Thus the innovative electronic system and method are able to fundamentally address the technical issue of missing relevant information data in an immense data exchange noise and improve quality experience for the users by customizing relationship network presentations according to specific user interests.

In an embodiment variant of the electronic system according to the invention an employee-based electronic link that serves as the basis for modelling the electronic link network is established by electronic data exchange between an employee and/or employee's unit of the electronic system and an electronic unit of the external actor interacting with the employee, as mentioned before. The data exchange represents an interaction of an employee with an external actor. In this embodiment variant the data exchange is an electronic messaging data transaction exchanged via a digital network. For example, the employee's unit and the external unit each comprise an electronic network structure like an electronic messaging tool based on standard messaging protocols for the transaction of messaging data between each other. For example, the employees' units have an electronic mailing tool for transmitting emails or an electronic meeting arrangement tool for organizing online meetings between several participants, such as between employees using the unit and the external actors using the external unit. A typical messaging protocol of such messaging tools is for example: simple mail transfer protocol (SMTP), post office protocol (POP), and internet message access protocol (IMAP), which can be enhanced by multipurpose internet mail extensions (MIME).

The messaging tools generate messaging data for example in form of email data and meeting arrangement data, respectively, to be transmitted between the units as commonly known. The messaging data may serve as metadata that is accessed by the capturing devices to capture the employment data and the link data. Common standards and protocols for messaging data provide a plurality of parameter values of messaging attributes, as will be explained in more detail below. Typically, the messaging data transmitted via the messaging tools includes at least an employee-based parameter value for one or more employee-based parameters identifying the employee/user account as the sender, recipient, meeting organizer or invitee of the messaging data transaction, and at least one interaction parameter value for one or more interaction parameters characterizing the interaction, for example the dates, categories, rankings, etc. of the message data transaction. The message data transaction represents the employee-based electronic link between the unit and the external unit. In case there is more than one electronic messaging data transaction exchanged between the unit and the external unit via the digital network, the totality of the interactions may represent the employee-based electronic link.

In an advantageous variant, the electronic system is able to identify new external actors and include them in the electronic link network. For example, a new sender of an email or a new host of an online meeting transmits an email or electronic meeting arrangement to the unit of the electronic system. The link network module comprises a data mining engine that dynamically triggers the trigger module to capture the employee data and the link data and/or the access unit to capture information data in case of a new interaction on the employee-based link. The trigger module automatically captures the employee data and link data of the message data exchange. The accumulation device assigns the interaction to the employee account identified from the employee data. Further, it extracts the external actor data from the link data and compares the actor data with previous actor accounts. In case there is no previous actor account comprising the same actor data, the accumulation device creates a new actor account and stores it in the repository unit. Preferably, the actor data at minimum includes parameter values for identifying the parameters “name”, particularly “first name” and “last name”, “email address”, “domain” and “contact ID”. This set of actor data creates a contact record for the external actor related to the user.

In another embodiment variant, the electronic system and method of the invention comprise an access unit connected or connectable to a data store and the accumulation device. The data store hosts electronic information data related to actor parameters of an external actor and/or an actor grouping. For example, the access unit connects to the data store by an application programming interface (API) for requesting data from the store and establishing a data flow to the access unit. The access unit retrieves information data related to actor parameters extracted by the accumulation device for an existing employee-based electronic link. The accumulation unit adds the information data to the link data and/or actor data. The data store is for example an online platform in form of a publicly accessible official registry, a commercial information platform, a restricted access data pool, or any other data library that is accessible via the digital network. Thus, the electronic system and method advantageously extend the data sets related to employee-based electronic links of the electronic link network. Specifically, the electronic system and method are able to use a company's proprietary data, e.g. credentials of employee accounts, and external actor data sources for extending the information basis about the employee-based electronic links.

In a further embodiment variant, the link network module comprises a grouping unit comprising a value matching logic, which is included in or connected to the accumulation device or connected to the repository unit. The value matching logic aggregates actor data of several actors or employee-based data of several employee accounts comprising an identical actor or employee-based parameter value as an external actor grouping data set or an employee grouping data set. For example, the value matching logic gathers all actor data sets that have the same actor category value, actor function value, etc. Similarly, the value matching logic gathers all employee-based data sets that have the same employee category value, employee function value, etc. Preferably, the grouping unit comprises a domain matching logic that identifies identical values of a domain parameter in various external actor data sets and groups the associated various external actor data sets as a domain grouping data set. Since the domain commonly corresponds to a company name, the domain grouping data set reflects the interaction of that company with an electronic unit of the electronic system.

Further, the grouping unit may aggregate the grouping data sets related to employee-based electronic links of several different employee accounts interacting with external actors identified by the identical actor parameter value. For example, all actor data connected to employee accounts of a sales department, marketing department, etc. of a company or of all company employees may be grouped when including the same actor parameter value. This way an employee-based electronic link is based on all interactions of the employees of the company with the external company. Advantageously, the electronic link network reflects the company to company relationship network, which is not possible with existing customer relationship management systems. To model a specific business to business network the specific parameter of the identical actor parameter value that corresponds to the company of interest, e.g. the domain parameter value, is selected by the parameter filters of the trigger table. The network modelling algorithm models the company interactions based on the employee-based electronic links according to their weighting factor as an output electronic link network representing the links to the company. Again, this is possible by exploiting the technical data protocols specifying the employee account associated with the employee's unit of the electronic system and the external unit or actor account even if the external account has not yet been recorded.

In a variant of the electronic system, the data exchange that serves as the foundation of the employee-based electronic link may include employee-based parameters of the electronic employee account representing a name, an email address, an email domain and/or an employee function. The employee-based parameter values detected by the capturing devices are for example textual data, respectively letter combination data, that is scanned by the capturing devices for capturing the specific parameter value. The link data may include actor parameters of an electronic actor account that represent an actor name, an actor email address, an actor email domain, an actor function and/or an actor identification code. The actor parameter values can be detected by the capturing devices as textual data, numerical or code data, or can be retrieved as additional information data from the data store. Further, the link data may include interaction parameters representing an interaction frequency, number of interactions, interaction time or time frame, interaction classification, number of link branches, link identification, link ranking and/or interaction type. The interaction parameter values can be detected by the capturing devices for example as textual, numerical or code data. For example, the interaction parameters indicate:
(1) an interaction frequency measured as the frequency of data exchange between the employee's unit, respectively the employee account, and an actor's external unit. The value of the interaction frequency may be represented as ratio of data exchange per day, week, month, quarter or year. Further, the value may be indicated as a frequency code, e.g. “active” or “green” for weekly data exchange, “fading” or “yellow” for quarterly data exchange, and “cold” or “grey” for yearly data exchange or similar coding.
(2) a total number of interactions measured as the number of data exchanges between the employee's unit, respectively the employee account, and an actor's external unit. The parameter value may be indicated as a simple interaction number or a number category, like category 1 for 1-5 data exchange interactions, category 2 for 6-10 data exchange interactions, category 3 for 11-20 data exchange interactions, etc.
(3) a number of data exchange interactions within a conversation. The parameter value is for example a number of responses following an initial email outreach interaction. The conversation may be identified by a reference topic or simple ID code. Data exchange between the employee's unit, respectively the employee account, and an actor's external unit on same thread ID, i.e. one and the same email exchange with multiple responses, will provide a better breakdown of the simple email interaction count. For example, hans_muster@firm.om exchanges 100 emails (50 inbound and 50 outbound) with johndhoo@ltdcorp.com. From these 100 emails, there are 2 different thread IDs. In other words, assuming that one email exchange (1 inbound and 1 outbound) has thread ID ABC, all other 98 email exchanges are on thread ID XYZ . . . that means there are technically two interactions one on ABC and one on XYZ . . . XYZ has triggered 49 responses back and forth.
(4) a number of link branches measured as the number of external units participating in the same data exchange of an interaction or employee-based electronic link. The parameter value or example is indicated as a number of recipients of an email sent from the employee's unit, respectively the employee account, to external units in one data exchange action. It has to be noted that this can be regarded as an extension of 3), where other actors are involved in one thread, i.e. with the same thread ID.
(5) a link type measured by detecting the data exchange direction comprising for example the parameter values of “unidirectional interaction” and “bi-directional interaction”. It is to be noted that the unidirectional or bi-directional is the determination of a relationship between a data exchange between the employee's unit, respectively the employee account, and an actor's external unit. If there is a bi-directional relationship based on a data exchange between the employee's unit, respectively the employee account, and an actor's external unit, then this can be used as trigger to capture frequency, intensity, etc. Uni-directional interactions or relationships will be disregarded i.e. no mining.
(6) a user function measured by scanning the data exchange for function indicators allocating the employee account or an external actor for example to a specific division or hierarchical level. Function parameter values are for example “sales division”, “marketing division”, “logistics division”, “junior management”, “senior management”, “C-suite”, etc. Also, the function parameter values can be retrieved from information data of a data store via the access unit. For data exchange between the employee's unit, respectively the employee account, and an actor's external unit the company with the employee accounts can enrich the views with parameters of the employee. In other words, hans_muster@firm.com is the employee account, the account unit firm.com can enrich divisional reference data, like Hans Muster as part of the firm's unit and in a corresponding department. Same information is not available via MIME data for the external unit. In other words, the network can be sorted by “who in said firm unit from said firm's department communicates with external units of LTD Corporation”. Further breakdown of the external actors is not available via MIME. But other information can be derived such as which external actors communicate e.g. with a communication suit of the firm. But again, these datapoints are only available by the employee actor and its firm's unit.
(7) an ownership assignment measured by detecting a count of employee accounts related to the same actor account comprising for example the parameter values for “exclusive” and “shared”. It is one of the uniqueness of the inventive system, not the count e.g. hans_muster@firm.com has unique relationship with johndhoo@ltdcorp.com meaning that no other internal actor is communicating with external actor i.e. the relationship is exclusive.

These and further parameter values are technical characteristics of the employee-based electronic links of the output electronic link network, that provide a quantified technical specification of the real relationship between the employee and the external actor or group of actors. The technical characteristics are extracted from the metadata generated or received automatically by the employee's units of the electronic system. The metadata serves as technical information source but cannot describe a relationship network. The metadata may include the parameter values as technical attributes for example in a messaging data protocol. The parameter values also may be embedded in the content of an electronic message transmitted by the data exchange and extracted from the content by the extraction algorithm of the accumulation device of the link network module. The extraction algorithm may include a text mining structure for scanning the textual content data related to employee-based parameters, interaction parameters, and actor parameters.

In yet another variant of the electronic system and method the weighting algorithm of the weighting unit assigns a weighting factors to one or more of the captured interaction parameters and/or to the employee-based electronic link by quantifying a link strength contribution of a data exchange interaction to the overall employee-based electronic link, as mentioned earlier. The link strength contribution is for example indicated as a strength in relation to other employee-based electronic links and/or to historical employee-based electronic link characteristics and their real-world equivalent. The weighting factor can be expressed as a categorization indicating a link strength of a parameter value of an interaction parameter. A categorization is for example defined as interaction time period categories, interaction frequency categories, interaction type categories, employee function categories, actor function categories and/or interaction classification categories. Each of these categorizations for example includes categories on a numerical or alphabetical scale. For example, on a scale from 1 to 5, a category 1 indicates a lowest link strength contribution, and a category 5 indicates a highest link strength contribution, while categories 2, 3 and 4 correspond to a gradually increasing link strength contribution. As an embodiment variant, no artificial intelligence (AI) or respectively large language model (LLM) is applied, where LLM is a type of AI program that can recognize and generate text, among other tasks. In particular, this concerns the relationship strength, if there is data exchange between multiple employee units into and one actor's external unit. Here a combination of (2), (3) and (4) can e.g. be applied. The weighting factors, respectively link strength contributions, may also e.g. be assessed by a machine learning structure of the weighting algorithm of the weighting unit, in particular a LLM structure. The machine learning structure assesses the link strength contribution of a data exchange interaction based on existing and/or historical employee data and actor data extracted associated to an employee account. For example, the machine learning structure is based on decision tree logic, association rule logic, clustering logic, sequential pattern logic, regression logic. The machine learning structure may draw learning data from the entirety of the interaction data acquired by the electronic system from the plurality of assessed employee-based electronic links of existing and historical relationship networks. As such the weighting unit refers to a very large data pool to compare newly assessed employee-based electronic links with data specifying past employee/customer relationships and their link strength, respectively intensity and importance. Further, the weighting categorizations values of different parameters can be consolidated as a single weighting category/factor for the interaction. Also, the weighting unit can assign a weighting factor to an employee-based electronic link established by the totality of interactions creating the link. For example, the weighting categories of the interaction parameter values are aggregated to define one single weighting category/factor for the employee-based electronic link. The weighting of the interactions and employee-based electronic links has the technical effect of translating vague social relations into quantifiable measurable electronic data exchange interactions and links.

A visualization unit can e.g. be connected or connectable to the trigger table for depicting the output link network as a visual representation. The presentation can include concentrical orbits of a selected interaction parameter and/or as a field for one or more selected actors parameter values. A diameter of the concentrical orbits depends on a weighting factor or weighting category of the selected interaction parameter of each external actor. The diameter of the actor fields depends on the weighting factor of the selected interaction parameter of the selected actors parameter values. The visualization unit for example is a monitor connected to the employee's unit of the electronic system. Thus, the output electronic link network may be depicted as a two-dimensional illustration on the visualization unit, showing the concentrical orbits and actor fields. The employee-based electronic links between the employee's unit, respectively the employee account, and the external actors may or may not be illustrated as connecting lines between the center representing the employee's unit and the actor fields. It est, it is the employee-based electronic links between the employee's unit, respectively the employee account, and the external actors as well as the external actor's electronic links between the external actor's unit, respectively the external account and the employee actors. In other words, the concentrical orbits can have one or many relationships i.e. one internal employee to his or her external actor's network (hans_muster@firm.com has one or more external contacts) or the external actor has one or more relationships into the “firm”. Boundaries between orbits, the actor fields and the connecting lines may be color coded to illustrated additional link characteristics. Alternatively, the visualization unit depicts the visual representation of the output link network as a table presentation. For example, the table presentation lists actor accounts of an actor grouping versus one or more employee accounts and connecting actor accounts with employee account by depicting connecting lines according to weighted link data.

In one embodiment variant of the electronic system of the invention, the system is realized as a web-based application with network-interfaces, wherein the employees' units are network-enabled devices and the network-interfaces connect the network-enabled devices to the trigger module. Further, the components of the link network module may be hosted in a cloud environment, that is for example the accumulation device, the repository unit, the weighting unit, the grouping unit and the access unit. Also, the trigger table may be hosted in the cloud environment and connect to the visualization unit via a network-interface. The visualization unit may be integrated in the network-enabled device. The electronic system can be established as a “software as a service” (SaaS) application the is implemented in the network-enabled devices of the employee user. The application does not have to be implemented in the network-enabled device of an external actor who interacts with the employee device, as explained above. For example, the electronic system 1 can be accessed via: (i) Network Flagship Applications (xplorer/Firefox, Safari, Chrome etc.), (ii) Micro-Front End (Email Plugin), and (iii) API Data Service.

In summary, the electronic method for automated detection and assessment of employee-based electronic links of an employee's unit to external actors on the unit according to the invention is based on an automated interaction data mining process for extracting an output electronic link network. The capturing devices of the trigger module automatically capture employee data at least one employee's unit, wherein the employee data comprises employee parameter values for employee parameters identifying at least one employee account or electronic employee's identification associated to an employee's unit or employee. Further, the capturing devices of the trigger module automatically capture link data comprising interaction parameter values for interaction parameters characterizing an employee-based electronic link between the employee account and the external actor. The accumulation device of the link network module extracts external actor data comprising actor parameter values for actor parameters from the link data. The accumulation device may store the employee data, link data and actor data in the repository unit. The weighting unit of the link network module automatically assigns a weighting factor to one or more of the captured interaction parameters of the link data and provides weighted link data for the employee-based electronic links, wherein a weighting factor correlates to a link strength of the parameter value of the weighted interaction parameter. The weighted link data may be stored in the repository unit. The trigger table provides an output electronic link network based on selected specific employee parameter values and/or interaction parameter values and automatically aggregates the employee-based electronic links associated with the selected specific parameters according to their weighting factor as the output link network.

The electronic method of the invention advantageously uses the data mining process to gather electronic data relevant for technically specifying the employee-based electronic links representing a physical relation between the employee of the employee account and an external actor, e.g. a customer or external company. The electronic data is gathered from the very large data volume exchanged between the employee's unit and the external actor. Further, the data mining process identifies electronic data representing parameters characterizing external actor accounts to technically identify the external actor form the link data. Furthermore, the data mining process includes processing the captured electronic data by the weighting algorithm, which can be performed as described above or as a variant by using a machine learning structure, to quantify a contribution of an interaction characteristics to the link strength by determining the weighting factor based on the interaction parameter values and/or employee-based parameter values. The weighting algorithm, respectively the machine learning structure, may determine the weighting factor according to predefined categories defining a link strength contribution. Alternatively, the weighting algorithm, respectively the machine learning structure, may determine the weighting factor by analyzing known link strengths of known link networks and identifying similarities and/or patterns in their interaction data with interaction data of the employee-based electronic links. Thus, the data mining process comprises a data fetching service and a relationship analysis service.

In a variant of the electronic method, the output electronic link network may be switched between a single employee account centered network and a group centered network based on employee and/or actor groupings. A grouping is based on identifying employee accounts or actor accounts characterized by an identical employee-based parameter value or actor parameter value, as mentioned above. The group centered network is based on selecting a specific grouping parameter value defining the identical parameter value of the grouping for the group centered network. In contrast to that the single employee account centered network is based on selecting individual employee parameter values and/or actor parameter values for an individual employee account or actor account. The switch is initiated by selecting ether a specific grouping parameter value or an individual employee parameter value or actor parameter value. Accordingly, the employee-based electronic links associated with the selected parameter values are automatically aggregated according to their weighting factor as a single employee account centered network or a group centered network by the trigger table. Particularly, a grouping can be characterized by an identical domain parameter value, wherein the domain parameter value is assigned to a company having several actors with actor accounts interacting with employee accounts. Thus, the electronic method of the invention can provide an employee view of the relationship network as well as a company view of the relationship network.

Overall the invention has e.g. the advantages to leverage the digital technology to translate technical data exchange into real-world relationship networks and enhance insights from electronic interaction between employees and external actors, which improves customer relationship monitoring and customer experience compared to the prior art systems, comprising
(i) a dynamic assessment of extern actors with the employee accounts of the electronic system, particularly based on automatically monitoring the activeness of an external actor account based on the interaction frequency, type of the relationship (“known” or “known of” contact), ownership of the actor account (“exclusive” or “shared”), grouping of actor account by company using domain matching, determining a functional affiliation e.g. contact serviced by Sales, Claims, etc., and assessing access of an actor accounts, e.g. relates to C-Suite;
(ii) an intelligent modelling process transforming electronic data extracted from data exchange between employee accounts and external actor account into an electronic link network replicating the real-world physical relationships between employees and external actors;
(iii) automated real-time monitoring and surveillance of employee-based electronic links as an integrated technical part of the electronic system capturing data exchanged between system units and trigger means providing users with real-time data flows regarding external actor activities;
(iv) an employee-specific automated presentation of the electronic link network, which comprises (1) a transparent processing and handling of network contributions from users and companies, (2) streamlined handling of network presentation independent of the network focus and network structure, (3) central data management reporting and analytics, and (4) the means for a clear focus on collaboration enablement and operational efficiency.

As relationships are key to a successful customer management strategy, the present invention introduced a novel technology for an electronic system and method to automatically establish a “Who Knows Who” network insight, particularly based on email interactions and calendar entries of employees with external customers, brokers, partners, and vendors. The insights gained with the electronic system and method of the invention is changing the entire contact management (also referred to as CDP-Customer Data Platforms). In other terms, the invention is able to transforms a conventional contact database into a network structure. Filling the gap of network transparency changes how companies operate. Taking the network dimension concept into account, the output electronic link network can serve as brain to distribute relevant insights across the network.

### BRIEF DESCRIPTION OF THE DRAWINGS

The present invention will be explained in more detail below relying on examples and with reference to these drawings in which:

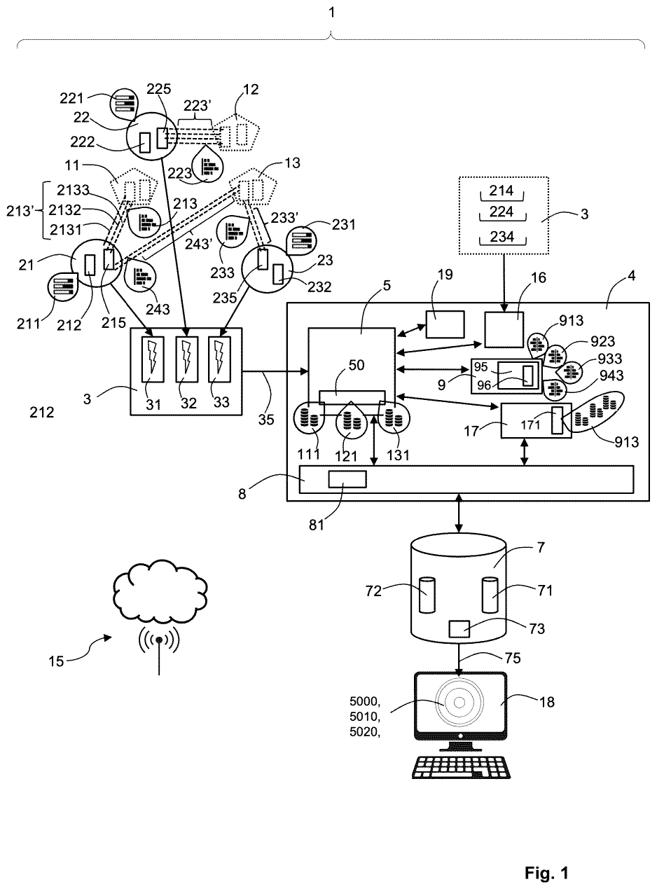

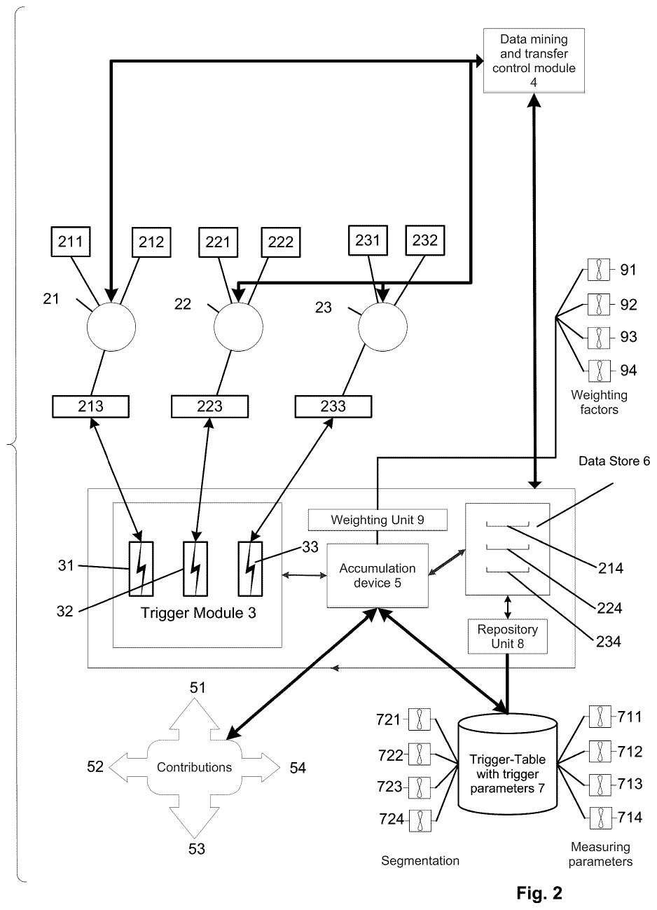

FIG. 1 shows a diagram, schematically illustrating a possible embodiment variant of the electronic system of the invention focusing on components of the electronic system and their linkage with each other.

FIG. 2 shows a further diagram, schematically illustrating another possible embodiment variant of the electronic system of the invention describing a data traffic of data exchange interactions or system units and a data mining process according to the invention.

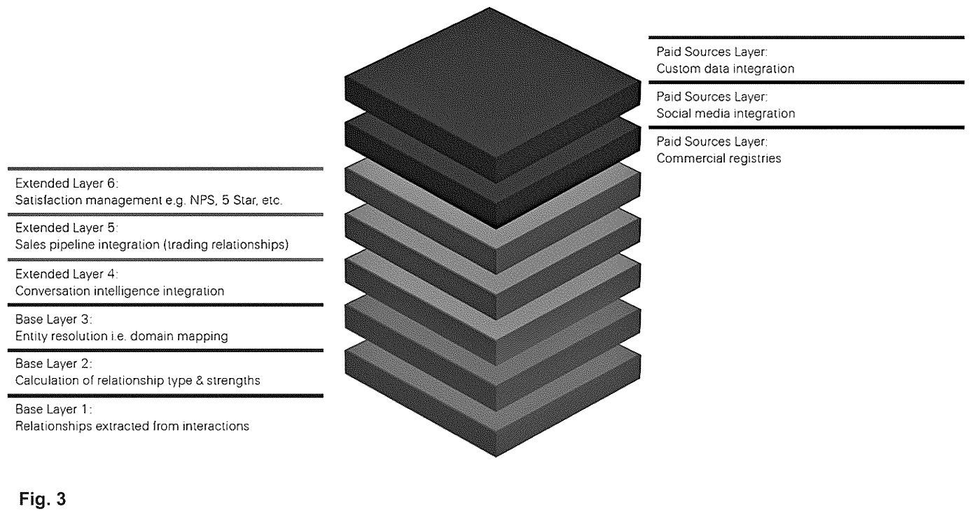

FIG. 3 shows a schematic illustration of core functionalities and additional functionalities of an example data mining engine of the electronic system and method of the invention illustrating network dimensions.

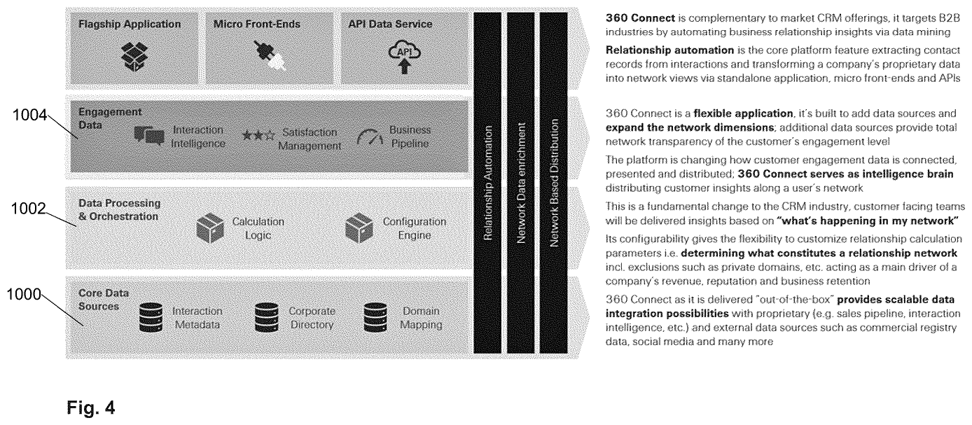

FIG. 4 provides a schematic overview of data layers, the data mining engine, interaction data forming different network dimensions and available user access points of the electronic system according to the invention.

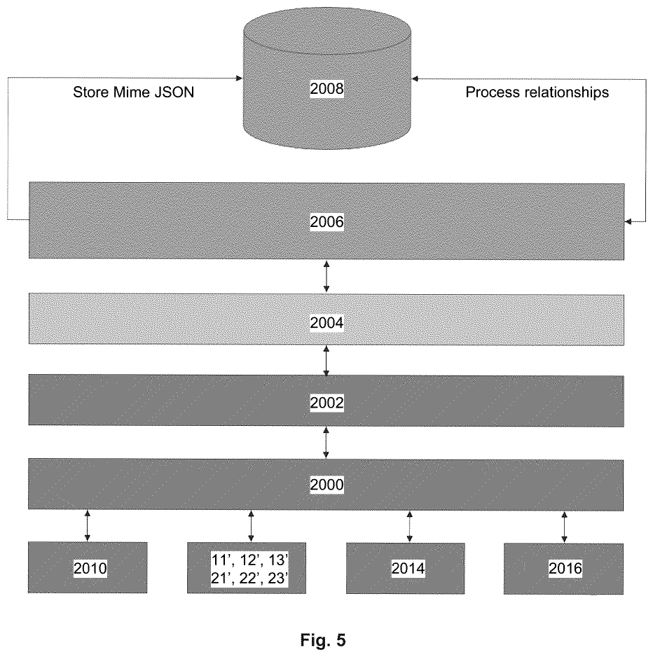

FIG. 5 shows a schematic illustration of an example technical implementation set up for an electronic system according to the invention.

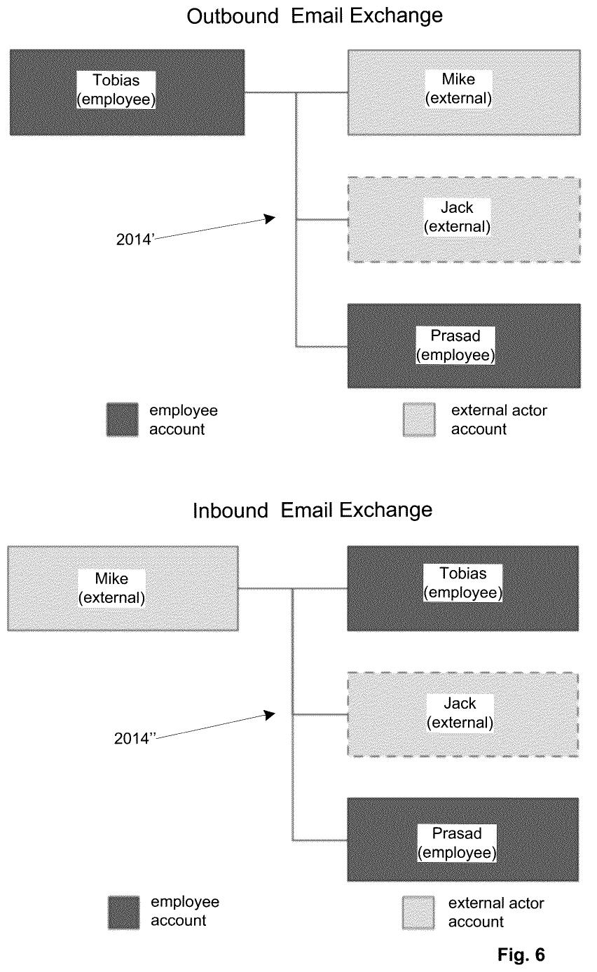

FIG. 6 shows two example diagrams for email data exchange serving as the basis for employee-based electronic links derived by the electronic system according to the invention.

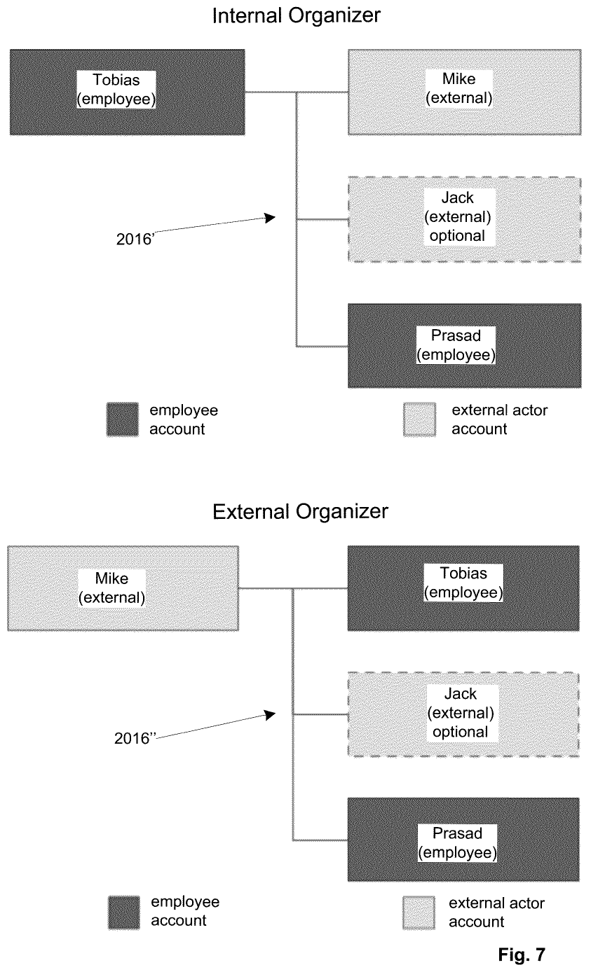

FIG. 7 shows two example diagrams for meeting event data exchange serving as the basis for employee-based electronic links derived by the electronic system according to the invention.

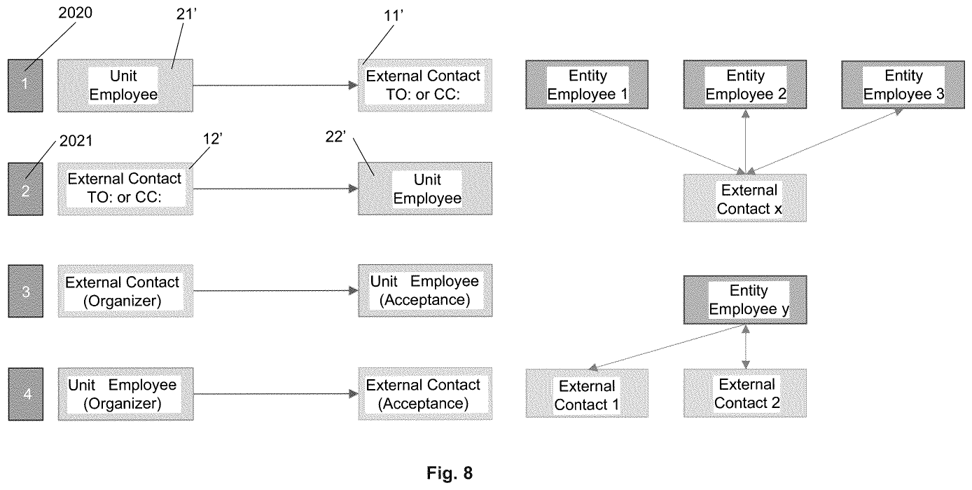

FIG. 8 shows an overview of interaction options establishing employee-based electronic links detected and assessed by the electronic system and method of the invention.

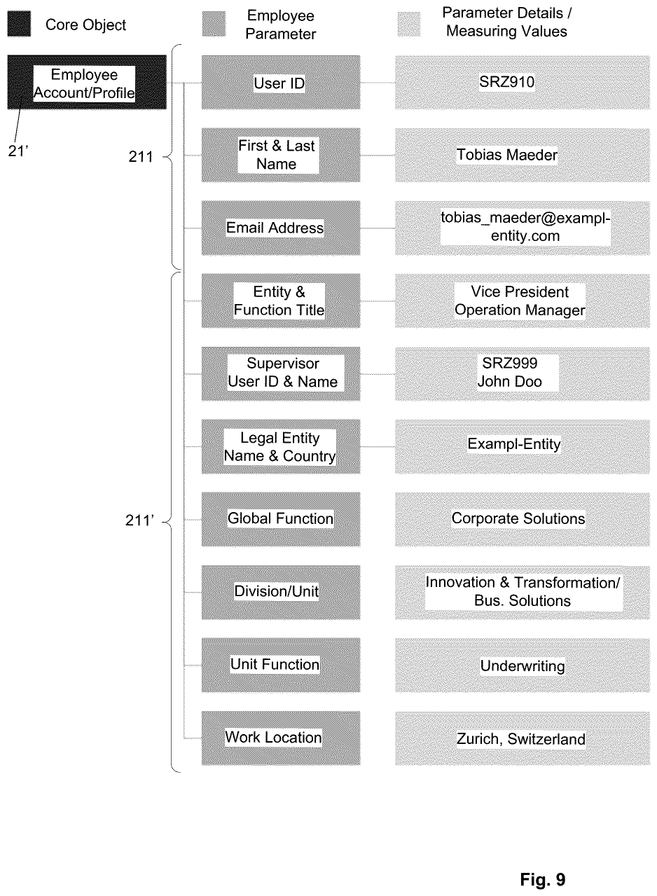

FIG. 9 illustrates an employee data profile of an example employee account as used for operating an employee's unit of the electronic system of the invention.

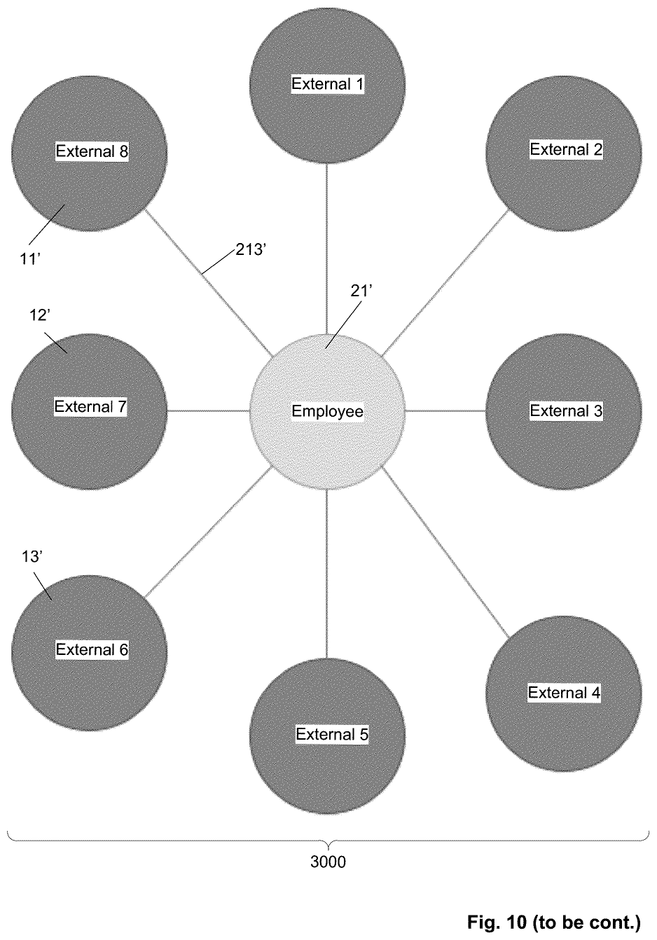

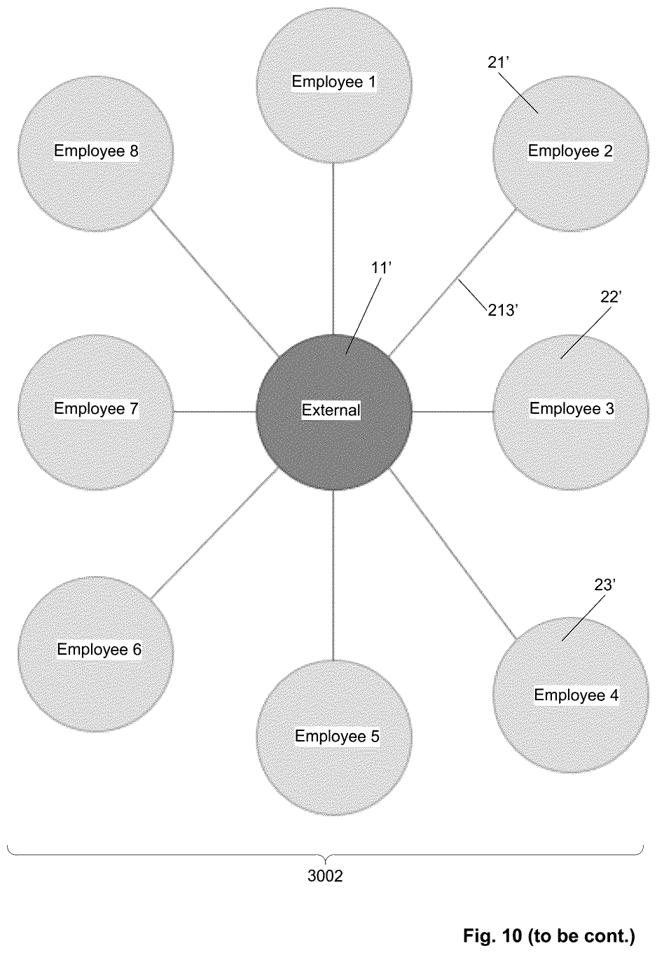

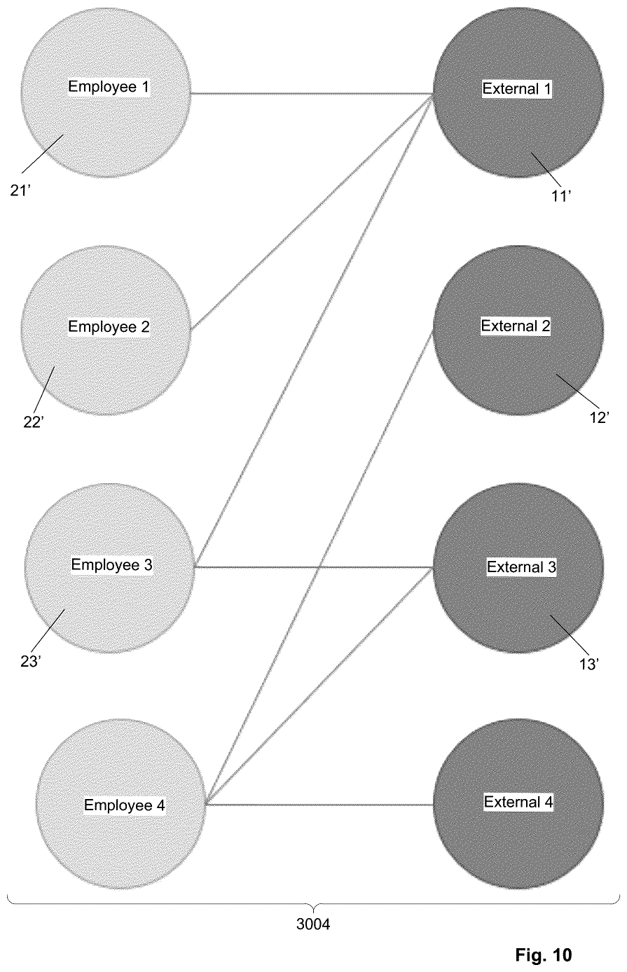

FIG. 10 illustrates three differing network views as a basis for an output electronic link network generated by the electronic system and method of the invention.

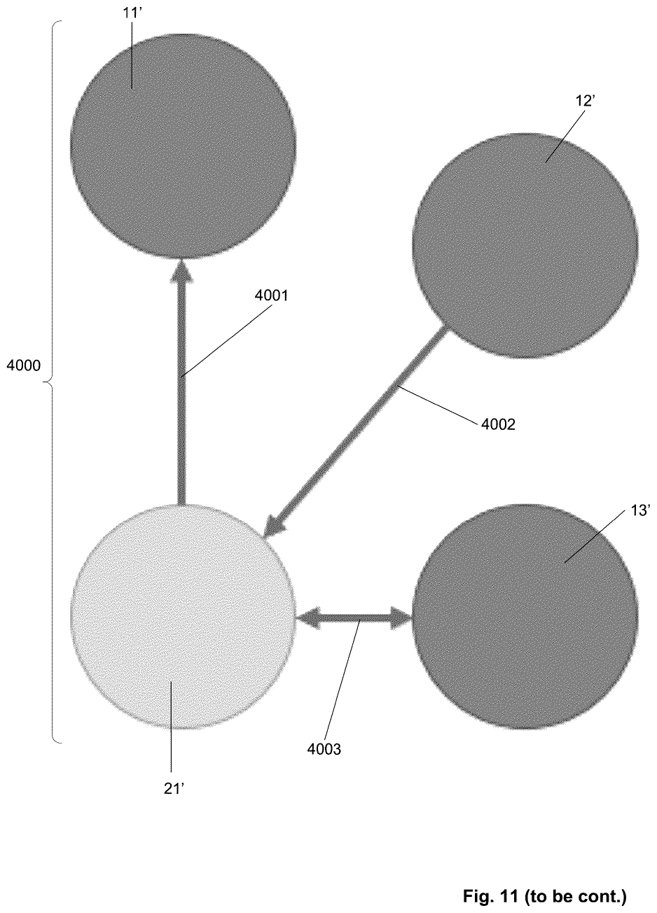

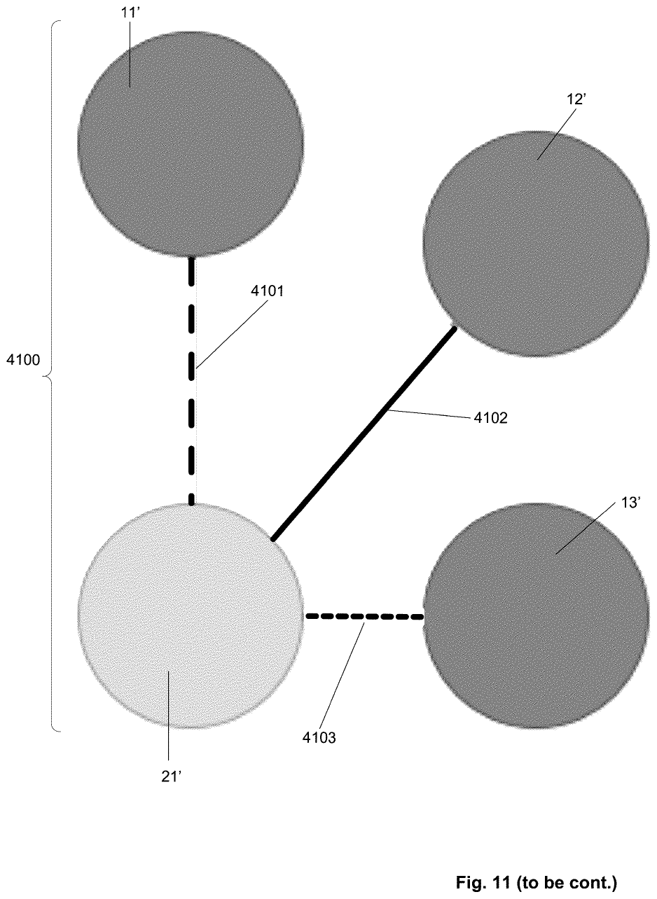

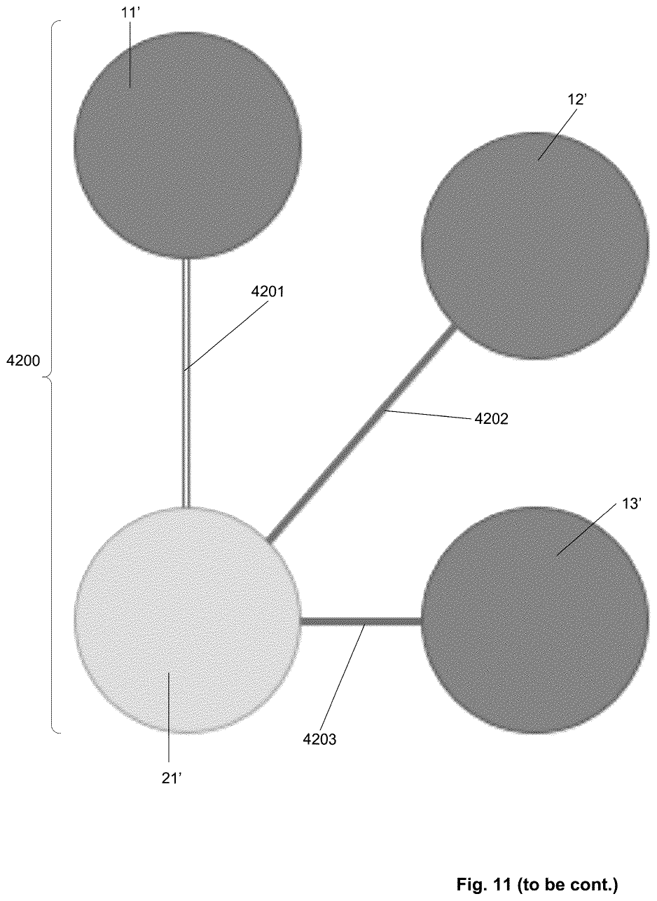

FIG. 11 illustrates the concept of employee-based electronic links based on four different types of interaction parameters and their weighting factors.

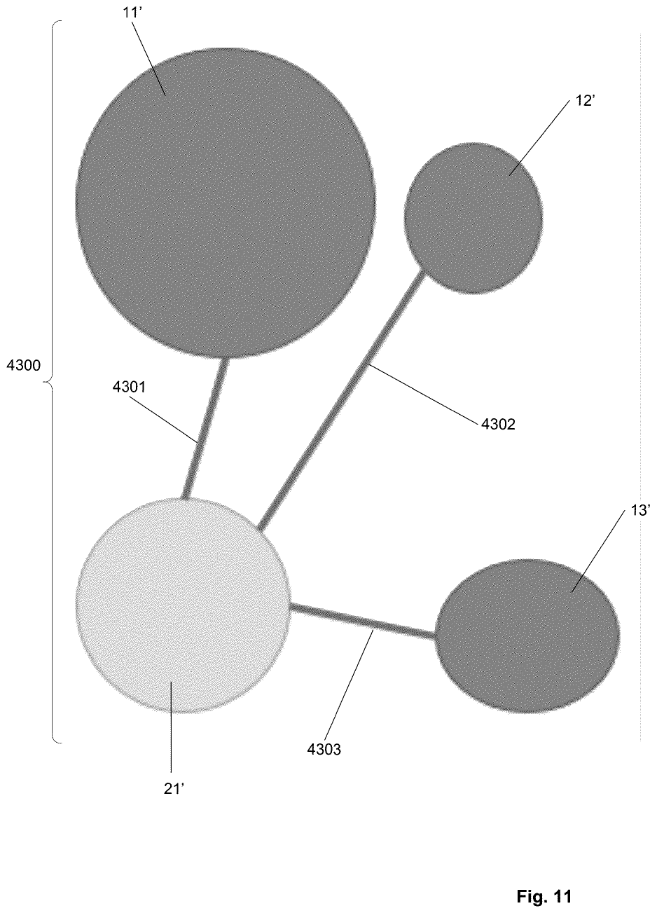

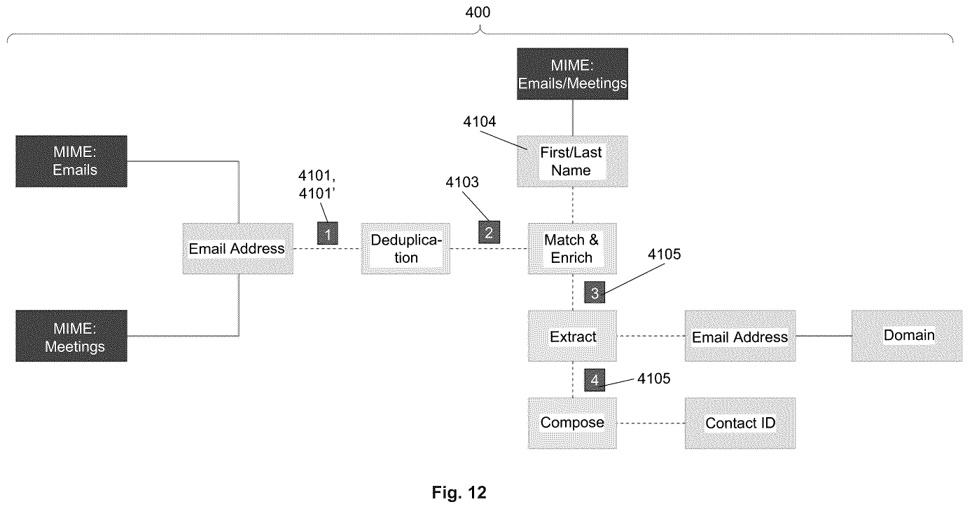

FIG. 12 shows a diagram illustrating steps of an example electronic method for automated detection and assessment of employee-based electronic links according to the invention.

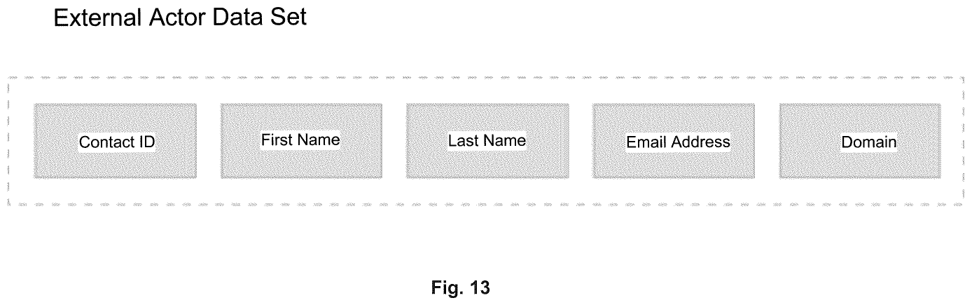

FIG. 13 illustrates an actor parameter data set including actor parameters representing a standard external contact record.

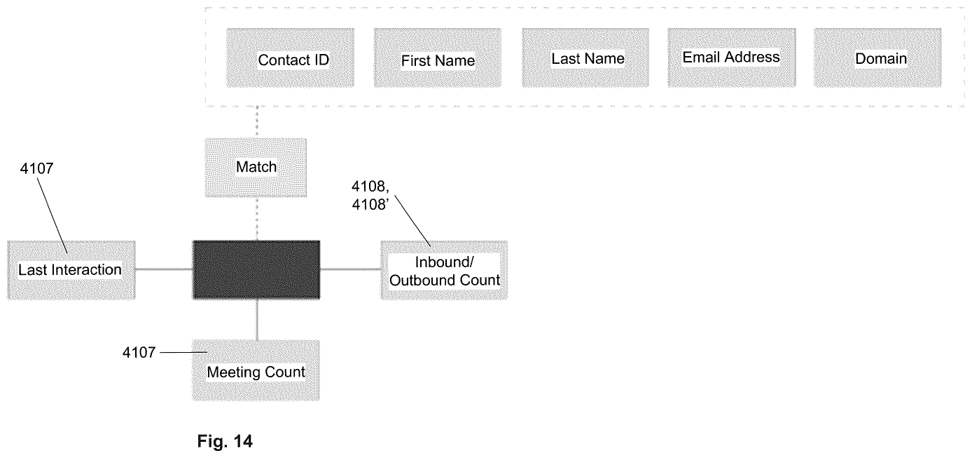

FIG. 14 illustrates an extended actor parameter data set including interaction data representing an extended external actor account.

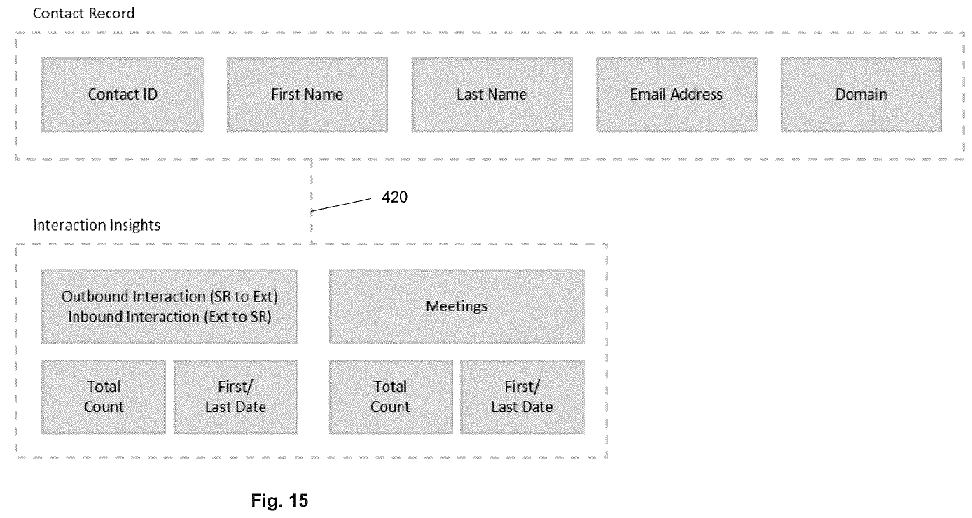

FIG. 15 illustrates an extended actor parameter data set based on weighted link data representing an extended external actor account.

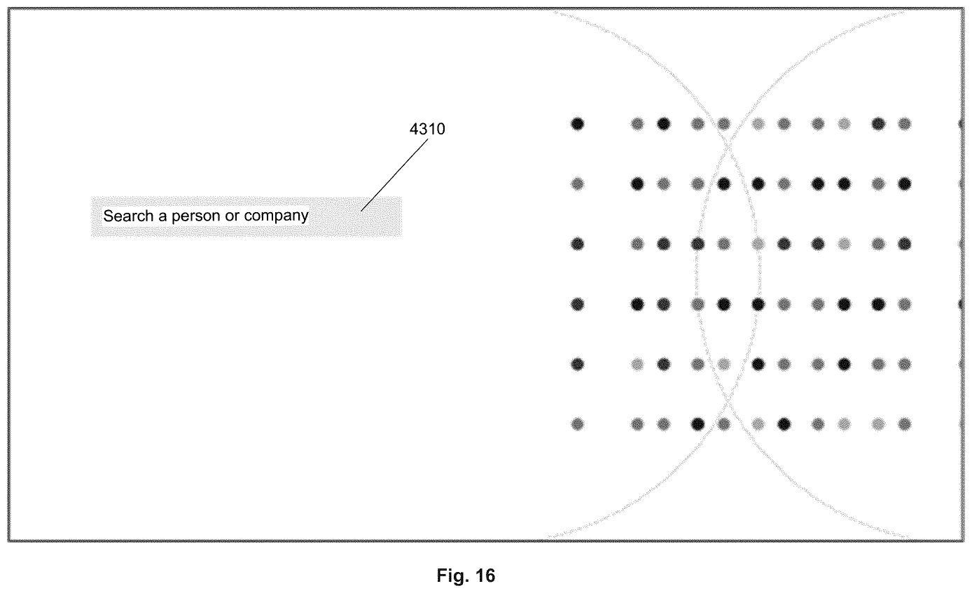

FIG. 16 shows an internet browser page “Home” of an Application Visualization connected to the electronic system of the invention.

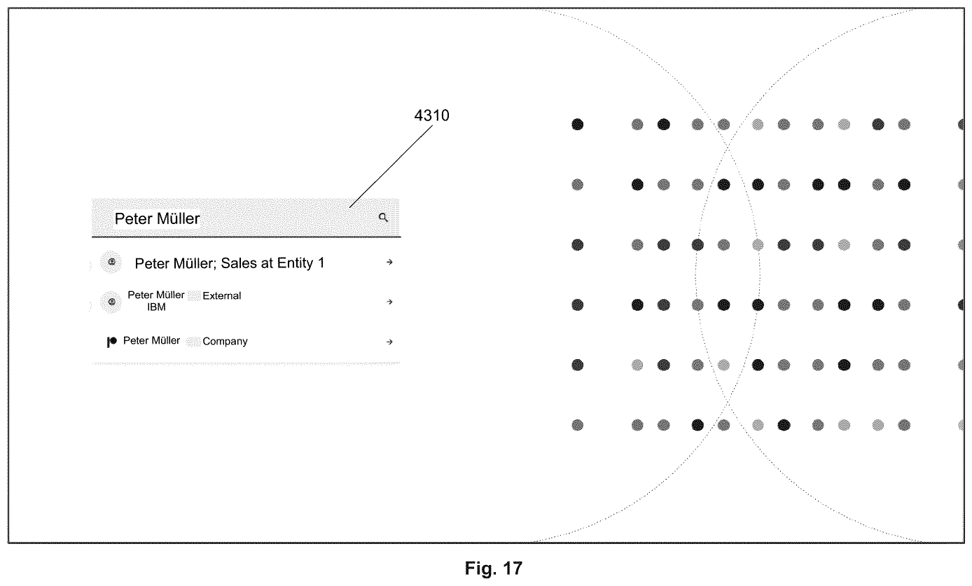

FIG. 17 shows an internet browser page “Search” of the Application Visualization comprising a pull down menu for parameter value selection.

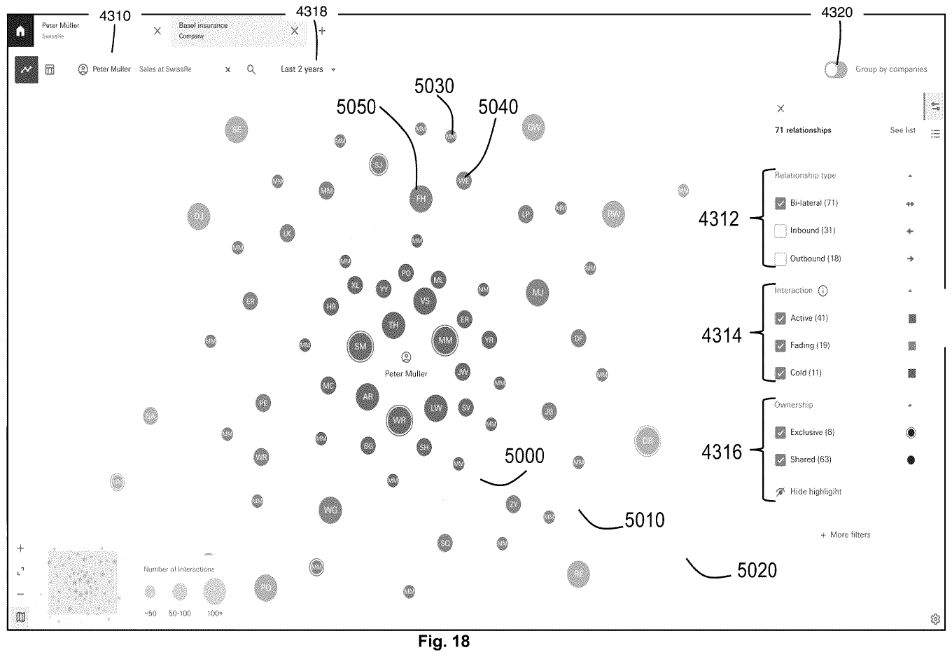

FIG. 18 shows an internet browser page “Result” of the Application Visualization presenting a first output electronic link network based on a “One to Many” format.

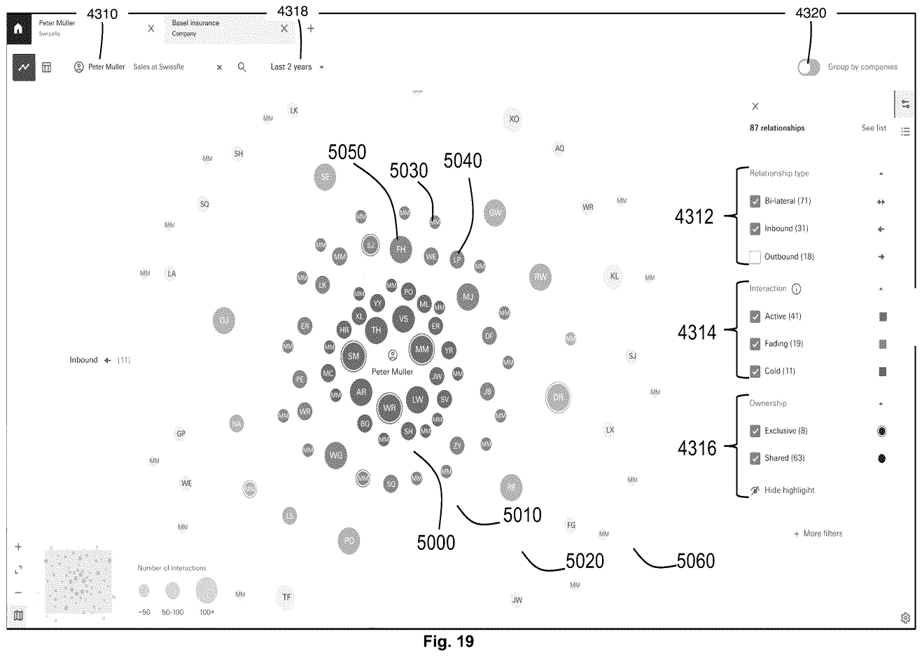

FIG. 19 shows an internet browser page “Result” of the Application Visualization presenting a second output electronic link network based on a “One to Many” format.

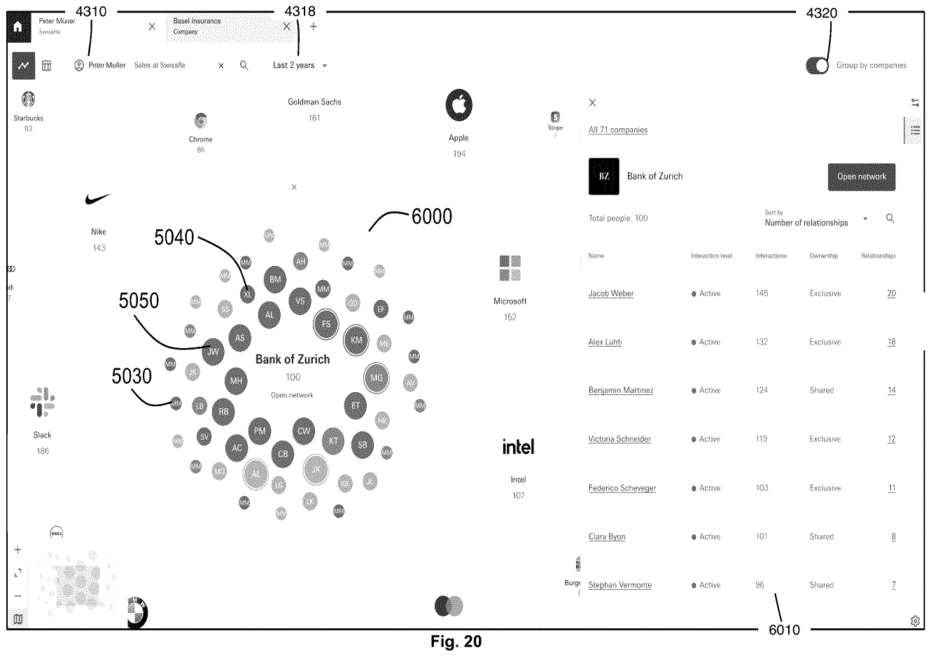

FIG. 20 shows an internet browser page “Result” of the Application Visualization presenting a third output electronic link network based on a “One to Many Company” format.

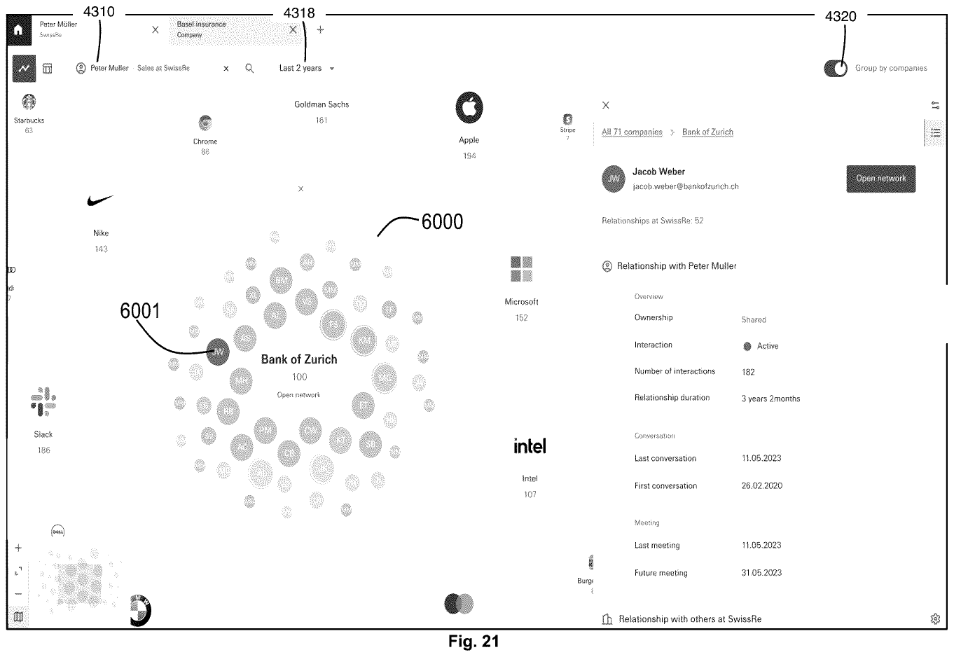

FIG. 21 shows an internet browser page “Result” of the Application Visualization presenting a variation of the third output electronic link network based on a “One to Many Company” format.

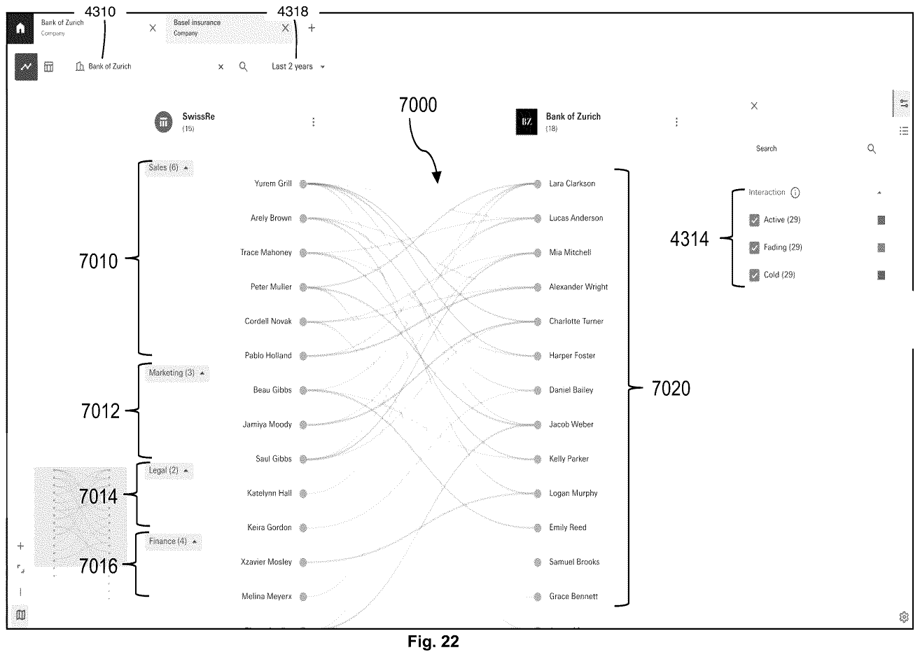

FIG. 22 shows an internet browser page “Result” of the Application Visualization presenting a fourth output electronic link network based on a “Many to Many Company” format.

FIG. 22 shows a contextualized data presentation using a plugin solution.

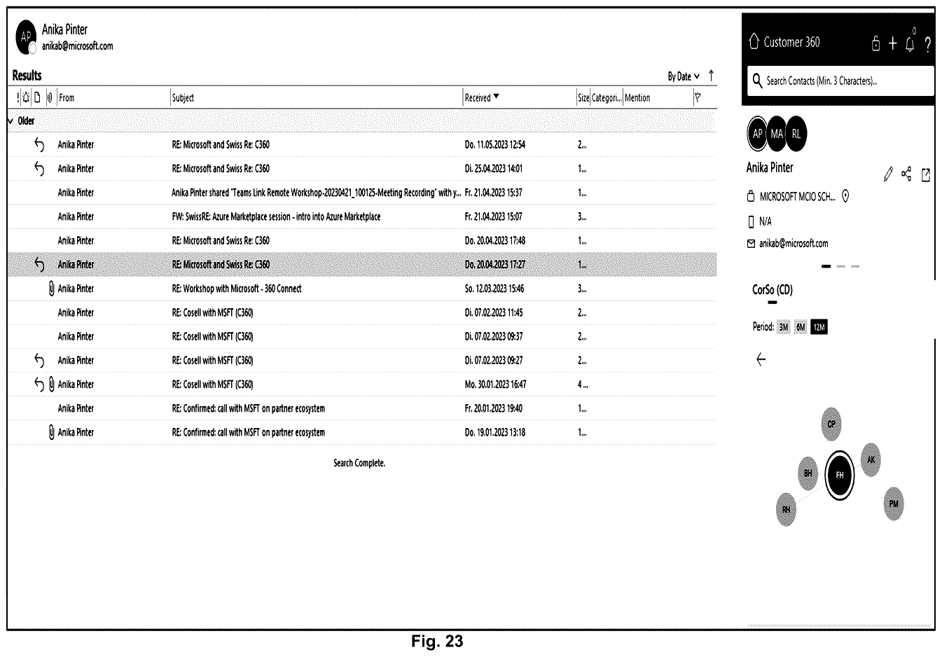

FIG. 23 shows a schematical diagram illustrating a variant of the electronic method of the invention showing method steps including data acquisition, data mining and data transfer control, network modelling and network visualization.

### DETAILED DESCRIPTION OF THE PREFERRED EMBODIMENTS

FIG. 1 schematically illustrates an example variant of the electronic system 1 for automated detection and assessment of employee-based electronic links of at least one employee and/or employee's unit 21, 22, 23 to external actors interacting with the at least one employee 21, 22, 23. The employees' units 21, 22, 23 can also be called system unit because they are components of the electronic system 1. Employees' units 21, 22, 23 are uniquely associable with a specific employee, e.g. using an electronic employee identification. The employees' units 21, 22, 23 can e.g. be realized as network-enabled devices, like a computer, laptop, tablet, smartphone, etc. The employees' units 21, 22, 23 are for example accessed to and operated by a user, particularly an employee, via an electronic employee account and/or electronic employee's identification comprising an employee profile holding employee-specific data. An external actor interacts with the employees' units 21, 22, 23 via an external unit 11, 12, 13, such as a network-enabled devices. The external units 11, 12, 13 are not components of the electronic system 1 and therefore are indicated as dotted lines. The external units 11, 12, 13 are accessed and operated by the external actors for example via an electronic actor account comprising an actor profile holding actor-specific data 211, 221, 231. For example, the employees' units 21, 22, 23 and the external units 11, 12, 13 are connected to the same digital network 15 and interact by generating an electronic data flow and exchanging data wirelessly via data channels established by the digital network. The employees' units 21, 22, 23 can e.g. comprise an electronic network structure 212, 222, 232 to connect to the digital network 15.

In the present example variant of the electronic system 1 the employees' units 21, 22, 23 further comprise a messaging tool 215, 225, 235, for example an emailing application for exchanging email data or an electronic meeting arrangement application for exchanging online meeting data. The messaging tools include functionalities for exchanging messaging data regarding sending, receiving, responding and managing email interactions, calendar integrations and contact management. The messaging tools may include messaging clients, such as desktop clients, web-based clients or mobile clients, and messaging servers, such as transfer, delivery and submission agents. Examples for emailing applications are: Microsoft Outlook, Gmail, Apple Mail, Mozilla Thunderbird, etc. Examples for meeting arrangement applications are: Skype, Zoom, Microsoft Teams, Google Meet, Slack, GoToMeeting, etc. The basis for data exchange by the messaging tools are messaging protocols that technically standardize and structure the data for the information exchange. The messaging tools facilitate the electronic messaging data transactions exchanged between the units 21, 22, 23 of the electronic system 1 and the external actor units 11, 12, 13 via the digital network 15.

An employee-based electronic link between an employee's unit 21, 22, 23 and an external actor unit 11, 12, 13 is defined by the sum of interactions between the system unit and the external actor unit. For example, the employee-based electronic link between unit 21 and external actor unit 11 is established by three electronic data exchange interactions 2131, 2132, 2133. It is to be noted, that the relationship is established by at least one in- and one out-bound between 11 and 21. Typically, three inbound will not qualify as relationship as unidirectional only. All interactions 2131, 2132, 2133 between the employee's unit 21 and the external actor unit 11 contribute to realizing an employee-based electronic link 213′ representing a technical relationship between the employee operating the employee's unit 21 and the external actor operating the external unit 11. Accordingly, all interactions between the employee's unit 22 and the external actor unit 12 establish an employee-based electronic link 223′, all interactions between the employee's unit 23 and the external actor unit 13 establish an employee-based electronic link 233′, and all interactions between the employee's unit 21 and the external actor unit 13 establish an employee-based electronic link 243″. While FIG. 1 illustrates only a few relationships for simplicity reasons, of course, in real-life there are many more electronic interactions and employee-based electronic links between many more system units and external units arising from a widespread relationship network between employees and external actors, like customer, vendors, contractors, etc.

The electronic system 1 is based on automated interaction data mining using a link network module 4, impact weighting using a weighting unit 9 for assessing the employee-based electronic links 213′, 223′, 233′, 243; and modelling a weighted electronic link network using a trigger table 7. The electronic system 1 comprises a trigger module 3 with a plurality of capturing devices 31, 32, 33, and is connected to the employee's units 21, 22, 23. For example, the trigger module 3 connects to the employees' units 21, 22, 23 via plug-in ports and assigns one of the capturing devices 31, 32, 33 to each of the employees' units 21, 22, 23. When the system units 21, 22, 23 interact with the external units 11, 12, 13, the capturing devices 31, 32, 33 automatically capture employee data 211, 221, 231 comprising employee-based parameter values for one or more employee-based parameters identifying at least one electronic employee account associated to the system unit 21, 22, 23. The captured employee data 211, 221, 231 define an employee data set. The employee-based parameter values for example specify the employee profile and provide the employee-specific data. Further, the capturing devices 31, 32, 33 automatically capture link data 213, 223, 233, 243 comprising interaction parameter values for one or more interaction parameters characterizing electronic interactions of the employee-based electronic links 213, 223″, 233′, 243′. The captured link data 213, 223, 233, 243 define a link data set, such as all the data of the data exchange interactions 2131, 2132, 2133 of the employee-based electronic link 213′. For example, the trigger module 3 connects to the data channel or the system unit and scans the data flow of the electronic interaction for detecting the employee data 211, 221, 231 and the link data 213, 223, 233, 243. Preferably, the trigger module 3 fetches employee data and link data for all employee accounts connected to units that are part of the electronic system 1. All the employee accounts for example belong to the same company. Thus, the electronic system 1 is able to assess the numerous interactions of the company with external actors.

The link network module 4 for data mining and data transfer control is connected to the trigger module 3. Alternatively, the trigger module 3 may be included in the network module 4. The link network module 4 comprises an accumulation device connected to the trigger module 3 and repository unit 8. The trigger module 3 automatically receives the employee data 211, 221, 231 and the link data 213, 223, 233 and provides it to the accumulation device 5. The accumulation device 5 comprises a data extraction algorithm 50 extracting external actor data 111, 121, 131 comprising actor parameter values of actor parameters included in the link data 213, 223, 233, 243. The external actor data 111, 121, 131 defines the actor data set that serves as a contact record comprising contact details of the external actor. In case there already exists an actor data set, respectively a contact record, comprising at least some of the actor data exchanged by the external unit, respectively for the actor account involved in the interaction, the actor data set of the contact record may be updated to avoid duplicates. In case there is no contact record for any of the actor data, a new contact record is registered. The accumulation device 5 stores the employee data 211, 221, 231, the link data 213, 223, 233, 243 and the external actor data 111, 121, 131 in the repository unit 8, which may be a cloud storage solution, a company owned server unit, or any other suitable repository device. Together the employee data 211, 221, 231, the link data 213, 223, 233, 243 and the external actor data 111, 121, 131 serve as an interaction data pool, which provides the foundation for the automated assessment of the employee-based electronic links and the modelling of the electronic link network.

The weighting unit 9 is connected to the accumulation device 5 and/or the repository unit 8 for accessing the interaction data pool and assessing the employee data 211, 221, 231, the link data 213, 223, 233, 243 and the external actor data 111, 121, 131. The weighting unit 9 comprises a weighting algorithm 95 for automatically assigning weighting factors 91, 92, 93, 94 (see FIG. 2) to one or more of the captured interaction parameters and/or to the employee-based electronic link. The interactions between an employee and an external actor, which contribute to the employee-based electronic link, are assessed for extracting the weighting factors 91, 92, 93, 94. A weighting factor correlates to a link strength of one or more of the interaction parameter values, respectively the capability of an interaction to contribute to the establishment of a link. For example, the weighting factor is determined from the employee data involved in the employee-based electronic link. Further, it may be determined from the link data defining an employee-based electronic link between a unit and an external actor. Furthermore, it may be determined from all employee-based electronic links of a group of employees or all of the employees, e.g. of employees of a department or of the whole company.

For example, the weighting algorithm 95 includes an artificial intelligence structure or machine learning structure 96, which extracts the weighting factors 91, 92, 93, 94 by assessing a link strength contribution of the data exchange interaction to the employee-based electronic link between the unit and the external actor. For example, the machine learning structure assesses a link strength contribution based on existing and/or historical employee data and/or actor data extracted for an employee account. The artificial intelligence structure or machine learning structure 96, is for example a regression, classification or clustering structure. The structure may be based on a linear regression logic, logistic regression logic, decision trees logic, random forests logic, gradient boosting machines, and neural networks, as mentioned earlier. For example, for linear models (e.g., linear regression, logistic regression) coefficients of the model can be used as weighting factors: for tree-based models, parameter importance scores may serve as weighting factors indicating the contribution of each parameter to the employee-based electronic link; and for neural networks, techniques like SHAP (SHapley Additive explanations) or LIME (Local Interpretable Model-agnostic Explanations) can be used to weight the contribution to the employee-based electronic link. Accordingly, the weighting unit 9 applies the weighting factors to the interaction parameter values and provides weighted link data 913, 923, 933, 943 to the accumulation device 5 or the repository unit 8 for specifying the link strength of the employee-based electronic links 213′, 223′, 233′, 243′. The weighted link data serves as an enriched contact record, that includes the actor data and additional information about the importance of an employee-based electronic link between an employee account and an actor account in relation to the sum of employee-based electronic links of that employee account to all external actor accounts interacting with the employee account and/or in relation to other employee account interacting with the external actors.

The link network module 4 is connected to a trigger table 7 providing an output electronic link network based on selected employee parameters and/or selected interaction parameters. The trigger table 7 comprises parameter filters 71, 72 for selecting specific employee parameter values and/or interaction parameter values that are of interest for the electronic link network. Further, it comprises a network modelling algorithm 73 modelling the employee-based electronic links associated with the selected specific parameters according to their weighting factor (i.e. link strength) as the output electronic link network. That means the output electronic link network shows the employee and/or company relationships with external actors by technically reflecting the link intensity, respectively link importance, of the employee-based electronic links. The network modelling algorithm for example is realized as a flow algorithm, optimizing algorithm, clustering algorithm, community detection algorithm, or simulation algorithm, as mentioned above. The network modelling algorithm serves the technical purpose of transferring the weighted link data into a weighted electronic link network quantifying the contribution of employee-based electronic links within the network. The output electronic link network identifies influential employee accounts, illustrates collaborations between employees and external actors, provides an organizational behavior structure, and illustrates information flow.

The example variant of the electronic system 1 of FIG. 1 comprises an access unit 16 that is connected or connectable to the accumulation device 5 and is connected to a data store 6 hosting external information data 214, 224, 234 related to actor parameters of an external actor and/or an actor grouping that is not included in the link data. The access unit 16 retrieves information data 214, 224, 234 related to actor parameters extracted by the accumulation device 5. The accumulation device 5 adds the information data 214, 224, 234 as additional information to the actor data 111, 121, 131, which creates an extended actor data set and provides an extended contact record for the external actor, respectively the actor account. For example, the access unit 16 downloads information data about a function parameter value in case the actor data did not include a parameter value for the function parameter of the actor account representing the function of the external actor, like “sales manager”, “marketing junior”, etc.

Further, in the example variant of the electronic system 1 of FIG. 1 the link network module 4 comprises a grouping unit 17 included in or connected to the accumulation device 5. The grouping unit comprising a value matching logic 171 aggregating actor data of several actors or employee data of several employee accounts comprising an identical actor parameter value, respectively employee-based parameter value. The several actor accounts and the several employee accounts are aggregated as an external actor grouping data set 172, respectively an employee grouping data set.

Consequently, also the employee-based electronic links related to the actor data and employee data are technically aggregated as a common link to the external actor grouping and the employee account grouping. In an advantageous example, the value matching logic 171 is a domain matching logic identifying identical values of a domain parameter in several external actor data sets and grouping the associated several actor data sets as a domain grouping data set. For example, the domain parameter indicates a company name value. Accordingly, all external actor data sets including the same domain parameter value belong to the same company and the corresponding actor data and employee-based electronic links are summarized in the grouping data set. Other actor parameters or employee-based parameters may serve as the basis for grouping. For example, function parameters, ranking parameters, etc.

In the example variant of FIG. 1, the electronic system 1 comprises a visualization unit 18 for depicting the output electronic link network as a visual representation of the employee-based electronic links involved in the selected employee parameters and/or selected interaction parameters. The visual representation can be realized of concentrical orbits of link strength and/or as a field for one or more selected actors parameter values or employee parameter values. The diameter of the concentrical orbits depends on the weighting factor of the selected interaction parameter indicating the link strength. The diameter of an actor value field or an employee or employee's unit value field depends on the weighting factor of the selected interaction parameter of the selected parameter values and also indicates the link strength. Alternatively, the visualization unit 18 may depict the output electronic link network as a table presentation listing actor accounts of an actor grouping versus one or more employee accounts and connecting actor accounts with employee account by depicting connections according to weighted link data. The visualization of the output electronic link network is discussed in more detail in FIGS. 17-23.

FIG. 2 shows a diagram illustrating a further possible embodiment variant of the electronic system1 of the invention describing electronic data traffic of data exchange interactions of system units and a data mining process according to the invention. The same reference numbers as in FIG. 1 are used for the same components or structures as in FIG. 2. The employees' units 21, 22, 23, respectively the employee accounts, are connected to the capturing devices 31, 32, 33 of the trigger module 3, which fetch the employee data 211, 221, 231 and the employee-based electronic link data 213, 223, 233 generated by the electronic interaction between the employee account and the external actor account. The trigger module 3 exchanges the data with the accumulation device 5 and triggers the extraction of the actor data set defining a contact record for the external actor. The accumulation device 5 is connected to the data store 6 via the access unit 16 for filling gaps in the actor data set and/or for adding information data that is useful for assessing the external actor, particularly for weighting the interactions and employee-based electronic links.

In the present example, the data store 6 provides a parameter value 214 for an actor parameter of the external actor unit 11 interacting with the employee's unit 21. Likewise, the data store 6 provides a parameter value 224 for an actor parameter of the external actor unit 11 interacting with the employee's unit 22, and a parameter value 234 for an actor parameter of the external actor unit 13 interacting with the employee unit 23. The additional actor parameter determines for example an additional email address connected to the external actor, a job function of the external actor, a hierarchical position, as mentioned above. Further, the accumulation device 5 is connected to the weighting unit 9, which applies weighting factors 91, 92, 93, 94 to the link data and the employee data for creating an enriched contact record providing additional interaction insights. In the present example, weighting factor 91 is based on processing values for the interaction parameter “total count of email interactions”, weighting factor 92 is based on processing values for the interaction parameter “first/last date of email interaction”, the weighting factor 93 is based on processing values for the interaction parameter “total count of attended online meetings”, and the weighting factor 94 is based on processing values for the interaction parameter “first/last date of attended online meeting”, as illustrated in FIGS. 13 and 14. Of course, other or additional employee parameters, interaction parameters or actor parameter may be assessed for weighting the interactions and employee-based electronic links.

The accumulation device 5 accumulates all contributions of the several interactions between the employee account and the external actor account for creating a quantified employee-based electronic link representing the relationship between the employee and the external actor. In the present example, the employee-based electronic link includes a first interaction contribution 51 resulting from “email in” data exchange, a second interaction contribution 52 resulting from “email out” data exchange, a third interaction contribution 53 resulting from “hosting meeting” data exchange, and a fourth interaction contribution 54 resulting from “participating in meeting” data exchange. All the data is stored in the repository unit 8, which also may provide storage for the modules, units and devices of the electronic system 1. The trigger module 3, the accumulation device 5, the repository unit 8, the weighting unit 9 and the access unit 16 are combined as one entity of the electronic system 1, as shown in FIG. 2, which may be realized as a cloud-based entity serving as the link network module 4 of the electronic system 1.

The link network module 4 controls the data mining and data transfer of the electronic system 1. It comprises the data mining engine dynamically triggering the trigger module to capture the employee data and the link data and/or the access unit to capture information data in case of a new interaction within the employee-based link. The accumulation device 5 automatically updates the actor data and the weighted link data. The link network module 4 communicates with the employees' units 21, 22, 23, and the combined entity of the trigger module 3, the accumulation device 5, the repository unit 8, the weighting unit 9 and the access unit 16 as well as with the trigger table 7. The trigger table 7 models the output electronic link network based on the selected employee parameters and/or selected interaction parameters selected by the parameter filters. The selection of specific data parameters restricts the output electronic link network model to employee-based electronic links based on the selected parameters. For example, a selectable parameter 711 refers to an individual employee name, a selectable parameter 712 refers to an actor domain, a selectable parameter 713 refers to an actor job function, and a selectable parameter 714 refers to an interaction classification. All these parameters are measured in the electronic data flow between an employee account and an actor account, as explained before. Further, the selection parameters may restrict the output electronic link network model to specified parameter values indicating a segmentation of the output electronic link network. For example, selectable parameter values 721 refer to interaction frequency values, selectable parameter values 722 refer to interaction type values, selectable parameter values 723 refer to actor ranking values, and selectable parameter values 724 refer to time range values. The trigger table extracts the employee-based electronic links according to the selected parameters and automatically models the output electronic link network for the physical relationships between the employees and external actors involved in these links.

The electronic system 1 of the invention is only as good as its underlying data sources. The strength of the electronic system 1 is to make it easy to expand the network dimensions based on a company's proprietary data and generally available external data sources. The electronic system 1 translates interaction engagement and common CRM data into an automated intelligent network modulation distributing information alongside a user's network.

As shown in FIG. 3, the electronic system 1 is not limited to automatically translating interaction data into relationship network views. The electronic system 1 provides Base Layers 1-3 which correspond to employee-based electronic links 213″, 223′, 233′, 243′ based on interactions between employee accounts and external actor accounts establishing data sets for contact records, weighting interactions and employee-based electronic links by weighting unit 9 to generate enriched contact records and creating employee/actor grouping by the grouping unit 17 as discussed above. Additional data sources can be added and evaluated, representing new network dimensions. This flexibility of expanding network dimensions is unique.

Additional network dimensions can be established by using data from e.g. internal data, such as a company's guest registry, and external contact enrichment sources, e.g. provided by the data store 6 etc. Particularly, the access unit 16 may connect to paid data sources, such as custom data sources, social media sources and commercial registries. Whenever a company has a data source with references to external contact data, this can potentially form another network dimension. The network modelling and visualization changes with each single layer. Taking extended layer 4, the link networking module 4 may comprise a conversation integration logic 19 which enables the electronic system 1 to track data relating to meeting chats and discussion notes of meetings with external actors. These are tagged to the contact records. Feeding this information into the network allows the users to extract topics and trends discussed within the network. Further, parameters of the meeting chats and discussion notes of meetings may be selected as the basis for modelling the output electronic link network. Along these lines the network can act as distribution mechanism sharing key meeting notes across to employees connected to the externals tagged in the discussion note. The electronic system 1 is thus able to automatically respond to the question “what is being discussed in my network”. Extended layer 5 may integrate data from sales interactions with external actors, such as sales pipeline interactions and trading interactions. Extended layer 6 may integrate data from satisfaction management tools and feedback tools, such as NP5, 5 Star, etc., measuring customer satisfaction and feedback parameters.

FIG. 4 gives an overview of the data layer, processing engine, interaction data forming different network dimensions and the available user access points. The electronic system 1 is designed to not being restricted to a single front-end but instead provide a flexible service offering. The service-based architecture of the electronic system and method of the invention represent a paradigm change away from prior art CRM systems as the system and the method enable seamless integration into other business applications.

The electronic system and method are complementary to market CRM offerings. They target business to business (B2B) industries by automating business relationship insights via data mining. Relationship automation is the core platform feature extracting contact records from interactions and transforming a company's proprietary data into network views via a standalone application: Micro front-ends or APIs. The electronic system 1 is a flexible application built to add data sources and expand the network dimensions dynamically according to changes in real-world relationship networks. Additional data sources provide total network transparency of a customer's or company's engagement level. The system is changing how customer engagement data is connected, presented and distributed. The electronic system 1 serves as intelligence brain distributing customer insights along a user's network. This is a fundamental change to the CRM industry. Customer facing employees will be delivered insights based on “what's happening in my network”. Its configurability gives the flexibility to customize relationship modelling parameters, i.e. determining what constitutes a relationship network incl. exclusions such as private domains, etc. acting as a main driver of a company's revenue, reputation and business retention. The electronic system 1 as it is delivered “out-of-the-box” provides scalable data integration possibilities with proprietary (e.g. sales pipeline interaction intelligence, etc.) and external data sources such as commercial registry data, social media and many more.

In FIG. 4, box 1000 “core data sources” refers to capturing the employee data and link data as interaction metadata, like the interaction data pool, including corporative directory data, and domain mapping by the domain matching logic. Box 1002 “data processing & orchestration” refers to the data mining process and network modelling by the trigger table 7, i.e. the extraction algorithm 50, the weighting algorithm 95, the machine learning structure 96, the modelling algorithm 73, further calculation logic and configuration engine. Box 1004 “engagement data” refers to integrating additional data layers in the data mining process, such as external data from the data store 6, satisfaction management data, business pipeline data, etc. Box 1004 “flagship application”, box 1006 “micro front-ends”, box 1008 “API data service” refer to application access and system integration.

It is to be noted, the interaction metadata is extracted from communication via email clients like Outlook, etc. The present inventive system is typically not detecting credentials of an electronic employee identification like the IP address. The inventive system extracts email metadata, e.g. hans_muster@firm.com is communicating with email address johndhoo@ltdcorp.com and extracting metadata from MIME Multipurpose Internet Mail Extensions (MIME) is a standard that extends the format of email messages to support text in character sets other than ASCII, as well as attachments of audio, video, images, and application programs. Message bodies may consist of multiple parts, and header information may be specified in non-ASCII character sets. Email messages with MIME formatting are typically transmitted with standard protocols, such as the Simple Mail Transfer Protocol (SMTP), the Post Office Protocol (POP), and the Internet Message Access Protocol (IMAP), i.e., MIME metadata without email content or subject.

FIG. 5 shows a schematic illustration of an example technical implementation set up for an architecture of the electronic system and method with a data mining and transfer engine as discussed above. The set up at least includes interacting architecture blocks 2000, 2002, 2004, 2006, 2008 as follows:

| Architecture | |
|---|---|
| block | Description |
| Block 2000 | The Graph API (e.g. Microsoft Graph API) offers a single |
| Graph API | endpoint, to provide access to rich, people-centric data and |
| | insights in cloud data pools, including Microsoft 365, Windows, |
| | and Enterprise Mobility + Security. MIME Engine uses the |
| | Graph API for the below services: |
| | 1. Fetch all members belonging to a mail group 2010; e.g. |
| | capture parameter values of employee-based parameters |
| | of user accounts 11′, 12′, 13′, 21′, 22′, 23′ and interaction |
| | parameters of an electronic email data exchange |
| | interaction 2014 and of an electronic meeting data |
| | exchange interaction 2016. |
| | 2. Fetch mail folders for each member of the group, e.g. |
| | gather parameter values from the messaging tools. |
| | 3. Fetch emails and meetings MIME data (only specific |
| | fields) for each member and mail folder; e.g. capture |
| | actor data from an email or meeting interaction. |
| Block 2002 | Application Registration is a managed identity to access the |
| Application | Graph API securely. It is allowed to access the Graph API based |
| Registration | on various application permissions. The MIME Engine uses |
| | below application permissions to access the Graph API: |
| | 1. Calendars.Read |
| | 2. Contacts.Read |
| | 3. GroupMember.Read.All |
| | 4. Mail.Read |
| | 5. User.Read.All |
| Block 2004 | An authentication logic, such as OAuth 2.0 and OpenID Connect |
| OAuth 2.0 | (OIDC), is used to authenticate and authorize the application |
| and OIDC | registration, e.g. with Microsoft Identity Platform, for accessing |
| | the Graph API. For example, in a next step MIME Engine uses |
| | OAuth 2.0 client ID and secret created in the application |
| | registration to get the bearer token when calling the Graph API. |
| Block 2006 | MIME Engine is an example of the core service for identifying |
| MIME Engine | the relationships between various employees (i.e. internal |
| | contacts) in the company with external actors (i.e. external |
| | contacts). It is comprised of two main sub-services: |
| | 1. The MIME data fetching service, which periodically calls |
| | the Graph API to fetch the emails and meetings metadata |
| | (MIME information) for the members of a mail group. It |
| | stores the output JSON to PostgreSQL database for |
| | further processing. |
| | 2. The relationship service, which reads the JSON stored in |
| | PostgreSQL, applies the logic to identify various types of |
| | relationships and stores the information in PostgreSQL |
| | database for further processing. |
| | The MIME Engine is an example of an architecture that serves |
| | as foundation for the data mining engine, particularly the link |
| | network module. |
| Block 2008 | PostgreSQL hosted in Azure is used to store the MIME data |
| PostgreSQL | JSON and the relationship data from MIME engine. i.e. the |
| Database | interaction data pool for modelling the output electronic link |
| | network. |

MIME stands for Multipurpose Internet Mail Extensions, which is an internet standard that extends the format capabilities of email and assists in data structuring for interaction data defining electronic interactions between employees and external actors. The MIME data of the interactions of an employee's account 21′, 22″, 23′ with external actor accounts 11′, 12, 13′ may serve as link data comprising interaction parameter values for one or more interaction parameters characterizing electronic interactions of the employee-based electronic links.

The electronic method includes email interaction data mining based on electronic email data exchange such as the interactions 2014. As mentioned above the employees' units 21, 22, 23 and external actor units 11, 12, 13 may comprise a messaging tool for the exchange of messaging data sets transmitting electronic mails and electronic meeting arrangements. Below list describes email data mined and processed once extracted via the data mining engine of the link network module 4, particularly the accumulation device 5. The list includes email metadata as included in email protocols identifying interactions of account activities that are turning into an electronic link network according to the invention. The listed attributes correspond to email parameters, respectively employee-based parameters and interactions parameters as present in emailing data exchange. The description specifies the parameters and explains possible parameter values.

| Attribute | Description |
|---|---|
| id | Unique identifier for the message |
| createdDateTime | The date and time the message was created |
| lastModifiedDateTime | The date and time the message was last changed |
| changeKey | The version of the message |
| categories | The categories associated with the message |
| receivedDateTime | The date and time the message was received |
| sentDateTime | The date and time the message was sent |
| hasAttachments | Indicates whether the message has attachments |
| internetMessageId | The message ID in the format specified by RFC2822 |
| importance | The importance of the message. The possible values are: |
| | low, normal, and high |
| parentFolderId | The unique identifier for the message's parent |
| | mailFolder |
| conversationId | The ID of the conversation the email belongs to |
| conversationIndex | Indicates the position of the message within the |
| | conversation |
| isDeliveryReceiptRequested | Indicates whether a delivery receipt is requested for the |
| | message |
| isReadReceiptRequested | Indicates whether a read receipt is requested for the |
| | message |
| isRead | Indicates whether the message has been read |
| isDraft | Indicates whether the message is a draft. A message is a |
| | draft if it hasn't been sent yet |
| sender | The account that is used to generate the message. In |
| | most cases, this value is the same as the from property |
| from | The owner of the mailbox from which the message is |
| | sent. In most cases, this value is the same as the sender |
| | property, except for sharing or delegation scenarios.. |
| toRecipients | The To: recipients for the message |
| ccRecipients | The Cc: recipients for the message |
| replyTo | The email addresses to use when replying |
| flag | The flag value that indicates the status, start date, due |
| | date, or completion date for the message. |

Particularly, the messaging data set exchanged by the emailing interactions includes external actor parameters of an external electronic actor account interacting with the electronic employee account, such as an actor name, an actor email address, an actor email domain and/or an actor function, and interaction parameters representing an interaction frequency, interaction number, interaction time and/or time frame, interaction classification, number of link branches, link identification, link ranking and/or interaction type. As mentioned, the link data including the actor parameter values are captured by the Graph API, respectively MIME Engine, which may include capturing devices as explained earlier.

FIG. 6 shows two example diagrams for email data exchanges, such as the electronic email data exchange interaction 2014, as a simplified overview of the metadata extracted from email exchanges and illustrates how the information is extracted from two email exchanges. FIG. 6 above shows an Outbound Email Exchange 2014′ and FIG. 6 below shows an Inbound Email Exchange 2014″ between an employee's unit, i.e. an internal employee account called “Tobias” and two external actor accounts called “Mike” and “Jack”: further the exchange includes another employee's unit, i.e. internal employee account, called “Prasad”. The exchange interaction comprises email metadata as listed above. The employee data and link data of the metadata is captured by the trigger module 3 and processed by the link network module 4. The information is transformed into a network model and identifies “who communicates with whom” incl. reference to time and date stamps:

Tobias is sending email to Mike, Prasad (both in TO) and Jack (in CC), below metadata is extracted:
Internet Message ID: ABC123 (exemplary ID)
Conversation ID: Internet Message ID ABC123 belongs to specific conversation
Conversation Index: Index position of Internet Message ID ABC123 is “1”
In Reply TO: No reply, first email
Created At: Time stamp, 11 Jan. 2023, 07:24 (CET)
From/TO/CC: Sender: Tobias, Recipient: Mike (external), Prasad (internal), CC: Jack (external)
Name: First and Last Name of external contact e.g. Mike

Mike is responding to Tobias and Prasad (both in TO) and Jack (in CC), below metadata is extracted:
Internet Message ID: DEF456 (exemplary ID)
Conversation ID: Internet Message ID ABC123 of first email is anchor identifier
Conversation Index: Index position of Internet Message ID DEF456 is “2”
In Reply TO: Reply to email with Internet Message ID: ABC123
Created At: Time stamp, 11 Jan. 2023, 09:34 (CET)
From/TO/CC: Sender: Mike, Recipient: Tobias (internal), Prasad (internal), CC Jack (external)
Name: First and Last Name of external contact e.g. Mike

Below paragraph provides an example protocol of the extracted link data represented in a JSON file format:

```
{
  “id”:
“AAMkADBhMTU2MDNmLTU5YWEtNGY3My05MTQ4LTZhOTY4OTRkOThkM
gBGAAAAAAA-
wv82pgo6QbRu39io4_GhBwD3aJNMiuQ1Qb_1WeQvzy03AAAAAAEJAAC49-
yZ1c5HR5mv1fZTX09AAAHtuOIBAAA=”,
  “flag”: {
    “flagStatus”: “notFlagged”
  },
  “from”: {
    “emailAddress”: {
      “name”: “John Doe”,
      “address”: “John_Doe@firm.com”
    }
  },
  “isRead”: true,
  “sender”: {
    “emailAddress”: {
      “name”: “John Doe”,
      “address”: “John_Doe@firm.com”
    }
  },
  “isDraft”: false,
  “replyTo”: [ ],
  “changeKey”: “DAAAABYAAAC49/yZ1c5HR5mv1fZTX09AAAJFOKI3”,
  “categories”: [ ],
  “importance”: “normal”,
  “@odata.etag”: “WΛ”DAAAABYAAAC49/yZ1c5HR5mv1fZTX09AAAJFOKI3\“”,
  “@odata.type”: “#microsoft.graph.eventMessageResponse”,
  “ccRecipients”: [ ],
  “sentDateTime”: “2023-12-08T10:35:25Z”,
  “toRecipients”: [
    {
      “emailAddress”: {
        “name”: “Jane Jill”,
        “address”: “Jane_Jill@acme.com”
      }
    }
  ],
  “conversationId”:
“AAQkADBhMTU2MDNmLTU5YWEtNGY3My05MTQ4LTZhOTY4OTRkOThkMg
AQAAhI7HOwxEGNsU_KAMaUuPk=”,
  “hasAttachments”: false,
  “parentFolderId”:
“AQMkADBhMTU2MDNmLTU5YWEALTRmNzMtOTE0OC02YTk2ODk0ZDk4ZD
IALgAAAz-C-zamCjpBtG7f2Kjj4aEBAPdok0yK5DVBv7VZ5C-
PLTcAAAIBCQAAAA==”,
  “createdDateTime”: “2023-12-08T10:35:25Z”,
  “receivedDateTime”: “2023-12-08T10:35:00Z”,
  “conversationIndex”: “AdopqJIBCEjsc7DEQY2xT4oAxpS4+QAACttAAAZg93w=”,
  “internetMessageId”:
“<AS8PR04MB91901FABFC72471929D5634AEF8AA@AS8PR04MB9190.eurprd04.
prod.outlook.com>”,
  “lastModifiedDateTime”: “2023-12-08T10:35:34Z”,
  “isReadReceiptRequested”: false,
  “isDeliveryReceiptRequested”: false
}
```

From the described email metadata in the JSON file, the link network module 4 receives parameter values for employee-based parameters of the employee account representing a name, an email address and an email domain. The parameter values are “John Doe”, “John_Doe@frim.com”, and “firm.com”. Further, the link network module 4 receives parameter values for interaction parameters of the electronic data exchange interaction representing a time of data sent, an external actor name, an external actor email address, an external actor email domain, and a conversation index. The parameter values are “2023-12-08T10:35:25Z”, “Jane Jill”, “Jane_Jill@acme.com”, “acme.com”, and “AdopqJIBCEjsc7DEQY2xT40AxpS4+QAACttAAAZg93w=”.

The inventive electronic system further comprises meeting interaction data mining based on electronic meeting data exchange such as the interaction 2016. Below list describes meeting event data mined and processed once extracted via the data mining engine of the link network module 4. The list includes meeting metadata as included in meeting arrangement protocols identifying interactions of electronic account activities that are turning into an electronic link network according to the invention. The listed attributes correspond to meeting parameters, respectively employee-based parameters and interactions parameters as present in meeting arrangement data exchange. The description specifies the parameters and explains possible parameter values:

| Attribute | Description |
|---|---|
| id | Unique identifier for the event. |
| createdDateTime | The Timestamp type represents date and time |
| | information using ISO 8601 format and is always in |
| | UTC time. |
| lastModifiedDateTime | The Timestamp type represents date and time |
| | information using ISO 8601 format and is always in |
| | UTC time. |
| changeKey | Identifies the version of the event object. Every time the |
| | event is changed, ChangeKey changes as well. |
| categories | The categories associated with the event. Each category |
| | corresponds to the displayName property of an |
| | outlookCategory defined for the user. |
| transactionId | A custom identifier specified by a client app for the |
| | server to avoid redundant POST operations in case of |
| | client retries to create the same event. |
| originalStartTimeZone | The start time zone that was set when the event was |
| | created. |
| originalEndTimeZone | The end time zone that was set when the event was |
| | created. |
| iCalUId | A unique identifier for an event across calendars. This |
| | ID is different for each occurrence in a recurring series. |
| reminderMinutesBeforeStart | The number of minutes before the event start time that |
| | the reminder alert occurs. |
| isReminderOn | Set to true if an alert is set to remind the user of the |
| | event. |
| has Attachments | Set to true if the event has attachments. |
| importance | The importance of the event. The possible values are: |
| | low, normal, high. |
| sensitivity | Possible values are: normal, personal, private, |
| | confidential. |
| isAllDay | Set to true if the event lasts all day. |
| isCancelled | Set to true if the event has been canceled. |
| isOrganizer | Set to true if the calendar owner (specified by the owner |
| | property of the calendar) is the organizer of the event |
| | (specified by the organizer property of the event) |
| responseRequested | Default is true, which represents the organizer would |
| | like an invitee to send a response to the event. |
| seriesMasterId | The ID for the recurring series master item, if this event |
| | is part of a recurring series. |
| showAs | The status to show. Possible values are: free, tentative, |
| | busy, oof, workingElsewhere, unknown. |
| type | The event type. Possible values are: singleInstance, |
| | occurrence, exception, seriesMaster. |
| isOnlineMeeting | True if this event has online meeting information, false |
| | otherwise. |
| onlineMeetingProvider | Represents the online meeting service provider. |
| allowNewTimeProposals | True if the meeting organizer allows invitees to propose |
| | a new time when responding; otherwise, false. |
| occurrenceId | |
| isDraft | Set to true if the user has updated the meeting in |
| | Outlook but has not sent the updates to attendees. Set to |
| | false if all changes have been sent, or if the event is an |
| | appointment without any attendees. |
| hideAttendees | When set to true, each attendee only sees themselves in |
| | the meeting request and meeting Tracking list. Default |
| | is false. |
| responseStatus | Indicates the type of response sent in response to an |
| | event message. |
| start | The start date, time, and time zone of the event. By |
| | default, the start time is in UTC. |
| end | The date, time, and time zone that the event ends. By |
| | default, the end time is in UTC. |
| location | The location of the event. |
| locations | The locations where the event is held or attended from. |
| | The location and locations properties always |
| | correspond with each other. |
| recurrence | The recurrence pattern for the event. |
| attendees | The collection of attendees for the event. |
| organizer | The organizer of the event. |

FIG. 7 shows two example diagrams for meeting arrangement data exchange as a simplified overview of the metadata extracted from meeting event exchanges and illustrates how the information is extracted from two meeting arrangement exchanges. FIG. 7 above shows an Outbound Meeting Exchange 2016′ with an internal employee account “Tobias” initiating a meeting, and FIG. 6 below shows an Inbound Meeting Exchange 2016″ with an external employee account “Mike” initiating a meeting between employee accounts and external actor accounts. The exchange interaction comprises meeting event metadata as listed above. Again, the employee data and link data of the metadata is captured by the trigger module 3 and processed by the link network module 4. The information is transformed into a network model and identifies “who meets with whom” incl. reference to time and date stamps:

Tobias invited Mike, Prasad (both Required) and Jack (Optional), below metadata is extracted:
iCalUID: ID987 (exemplary ID)
Recurring: One time meeting, not recurring
Organizer: Extract Tobias (employee) as organizer
Cancelled: Validation if cancellations have taken place prior or after meeting time
Attendees: Extraction of Unit/Company and External attendees
Sensitivity: Private, Personal, Confidential
Start/End Time: Calculation of meeting duration and validation base for cancelled and declined
Name: First and Last Name of external contact e.g. Mike

Below paragraph provides an example protocol of the extracted interaction data represented in a JSON file format:

```
{
  “id”:
“AAMkADRjOWNiYzFkLTRmMjAtNGU2Yy04NDQ5LTE2Nzg1N2QzMzYwMAB
GAAAAAABwT4Wtv_tSRJo3K6glq9YzBwD-
XfMxlVWkSazFbzA6CD0GAAAAAAENAAChi9fc4Rk1SaQNgilryLMkAAMc_14K
AAA=”,
  “end”: {
    “dateTime”: “2023-12-12T00:45:00.0000000”,
    “timeZone”: “UTC”
  },
  “type”: “singleInstance”,
  “start”: {
    “dateTime”: “2023-12-12T00:00:00.0000000”,
    “timeZone”: “UTC”
  },
  “showAs”: “tentative”,
  “iCalUId”:
“040000008200E00074C5B7101A82E0080000000000A8F92DD529DA010000000000
0000001000000049C6995E17344F45BFDD37EBCAD05051”,
  “isDraft”: false,
  “isAllDay”: false,
  “location”: {
    “uniqueId”: “One Main St”,
    “displayName”: “One Main St”,
    “locationType”: “default”,
    “uniqueIdType”: “private”
  },
  “attendees”: [
    {
      “type”: “required”,
      “status”: {
        “time”: “0001-01-01T00:00:00Z”,
        “response”: “none”
      },
      “emailAddress”: {
        “name”: “John Doe”,
        “address”: “john.doe@acme.com”
      }
    },
    {
      “type”: “required”,
      “status”: {
        “time”: “0001-01-01T00:00:00Z”,
        “response”: “none”
      },
      “emailAddress”: {
        “name”: “Jane Jill”,
        “address”: “Jane_Jill@firm.com”
      }
    }
  ],
  “changeKey”: “oYvX3OEZNUmkDYIpa8izJAADGlcqBA==”,
  “locations”: [
    {
      “uniqueId”: “One Main St”,
      “displayName”: “One Main St”,
      “locationType”: “default”,
      “uniqueIdType”: “private”
    }
  ],
  “organizer”: {
    “emailAddress”: {
      “name”: “John Doe”,
      “address”: “john.doe@acme.com”
    }
  },
  “categories”: [ ],
  “importance”: “normal”,
  “recurrence”: null,
  “@odata.etag”: “WΛ”oYvX3OEZNUmkDYIpa8izJAADGlcqBA==\“”,
  “isCancelled”: false,
  “isOrganizer”: false,
  “sensitivity”: “normal”,
  “isReminderOn”: true,
  “hideAttendees”: false,
  “transactionId”: null,
  “hasAttachments”: false,
  “responseStatus”: {
    “time”: “0001-01-01T00:00:00Z”,
    “response”: “notResponded”
  },
  “seriesMasterId”: null,
  “createdDateTime”: “2023-12-08T04:53:28.3891986Z”,
  “isOnlineMeeting”: false,
  “responseRequested”: true,
  “originalEndTimeZone”: “Singapore Standard Time”,
  “lastModifiedDateTime”: “2023-12-08T04:53:29.553639Z”,
  “allowNewTimeProposals”: true,
  “onlineMeetingProvider”: “unknown”,
  “originalStartTimeZone”: “Singapore Standard Time”,
  “reminderMinutesBeforeStart”: 15
          }
```

FIG. 8 shows an overview of interaction options establishing employee-based electronic links detected and assessed by the electronic system and method of the invention. The overview lists four interaction options between an employee account 21′, 22′, 23′, i.e. a system unit 21, 22, 23, and an external actor unit 11, 12, 13 based on email data exchange, as discussed for FIG. 6, and meeting arrangement data exchange, as discussed for FIG. 7. Every external actor has at least one interaction reference (email or meeting) into an employee. An interaction reference—from an external actor perspective is either sending an email to an employee, receiving an email from an employee (TO: or CC:) or organizing/accepting a meeting. FIG. 8 left lists a summary of the interaction logic:
1. Interaction 2020: Employee establishes unidirectional relationship with external actor (assuming no further interaction happened)
2. Interaction 2021: External actor establishes unidirectional relationship with employee (assuming no further interaction happened)
3. Interaction 2022: Same as interaction 2021, just via meeting invite
4. Interaction 2023: Same as interaction 2020, just via meeting invite

FIG. 8 on the right indicates the mix of uni-directional and bi-directional interactions, as will be explained in more detail in FIG. 10.

The electronic system and method of the invention may comprise an active directory 81. The directory may be hosted for example in the repository unit 8. The directory 81 comprises proprietary data of a company platform hosting several user accounts in form of employee accounts 21′, 22′, 23′ as used for operating the system units 21, 22, 23 of the electronic system 1. FIG. 9 shows a non-conclusive summary of the systems employee data information and the systems employee account profile. Particularly, FIG. 9 illustrates an employee data profile defining credentials of the example employee account 21′. The active directory data serves as additional data to complement employee data captured from the electronic interactions of the employee-based electronic links. For example, the employee account 21′ is specified by the employee data 211 indicating the employee parameters “user ID”, “name”, and “email address” having the parameter values “SRZ910”, “Tobias Maeder”, and “tobias_maeder@entity.com”. Additionally, the employee account 21′ may be specified by the employee data 211′ indicating the employee parameters “corporate & functional title”, “supervisor user ID & name”, “legal entity name & country”, “global function”, etc. having the parameter values “Vice President Operations Manager”, “SRZ999John Doo”, etc. The additional information data may for example be accessed by the access unit 17.

As mentioned above, the additional data facilitates additional levels of network modelling. Also, this data is relevant to complement the relationship insights extracted from the interaction data pool. The additional data is advantageously used for determining weighting factors for employee-based electronic links as the parameter values may serve as link strength indicators. Generally, only internally “public” data shall be used to complement the relationship views. All information data 211 and 211′ as listed in FIG. 9 can be of relevance to enriching the employee data captured from a data exchange between a system unit and an external actor. Particularly, the parameters and parameter values of the data may serve as network filters, which can be selected by the parameter filter 71, 72 of the trigger table 7. For example, the filters select the name parameter value “Broker X” and the employee accounts including the business function parameter “underwriting” as a basis for a customized electronic link network modelled by the electronic system.

The electronic system of the invention comprises a core network logic, such as the network modelling algorithm 73, to compile the output electronic link network as a technical presentation of the relationships between employees and external actors. As mentioned above, the network modelling is based on selected interaction parameters, their values captured by the trigger module 3, and their corresponding weighting factors. FIG. 10 describes three different network views: (1) Upper left in FIG. 10 illustrates a first view 3000 “One to Many.” (one internal employee account 21′ exchanging data with many external actor accounts 11′, 12′, 13″): The network view 3000 takes an employee and identifies its relationships into one or multiple external contacts. Basically, it connects one internal employee account 21′ with associated external contacts, i.e. external actor accounts 11′, 12′, 13″, by employee-based electronic links extracted from MIME, such as the employee-based electronic link 213″; (2) Upper right in FIG. 10 illustrates a second view 3002 “One to Many” (one external actor account 11′ exchanging data with many internal employee accounts 21′, 22′, 23′): This network type takes an external contact and identifies its relationships with one or multiple employees. Basically, it connects one external actor account 11′ with associated internal employee accounts 21′, 22′, 23′ by employee-based electronic links extracted from MIME, such as the employee-based electronic link 213″: (3) below in FIG. 10 illustrates a third view 3004 “Many to Many” representing a company view (many internal employee accounts 21′, 22′, 23′ exchanging data with many external actor accounts 11′, 12, 13″): For this view the domain matching logic groups all external contacts comprising the same domain parameter value indicating that they belong to the same company and matches the employee accounts being linked with these actor accounts. This view is restricted to one external company. For the Company view 3004 the value matching logic 171 is realized as a domain matching logic. For example, IBM as a global corporate actor has different email domains. The electronic method of the invention may embed the different domains e.g. ibm.co, ibm.ch, etc. as foundation of the external contact to company grouping.

FIG. 11 illustrates the concept of employee-based electronic links based on four different exemplary types of interactions defined by their interaction parameter values and their weighting factors. As mentioned earlier, the weighting factor correlates to a link strength and defines the contribution of an interaction to the overall employee-based electronic link, as well as the contribution of an employee-based electronic link to the overall electronic link network. The link strength, respectively the weighting factor, for example may be determined by measuring the employee and interaction parameters and capturing additional external link parameter data or gathering additional link parameter data from internal repositories related to the interactions and links. All the data specifying the employee and interaction parameter values serves as the interaction data pool for determining the weighting by the weighting unit 9, which then provides weighted link data. In short, FIG. 11 illustrates details on the strength and intensity of differing employee-based electronic links of an employee account 21′ with external actor accounts 11′, 12″, 13′, i.e. it illustrates the quality of differing relationships between an employee and external actors.

The upper left diagram in FIG. 11 shows a first type of interaction 4000 illustrating a relationship or link type interaction. The link type is measured by detecting the data exchange direction. The interaction 4001 between the employee account 21′ and the actor account 11′ has the interaction parameter value “outgoing unidirectional interaction”. The interaction 4002 between the employee account 21′ and the actor account 12′ has the interaction parameter value “incoming unidirectional interaction”. The interaction 4003 between the employee account 21′ and the actor account 13′ has the interaction parameter value “bi-directional interaction”. In short, whenever there is a bi-directional interaction between an employee and external actor, this is considered as a strong relationship, i.e. the employee and the external contact know of each other, having a strong weighting factor, e.g. a factor 1.0. If there is a unidirectional interaction only, this is considered a “knows of” i.e. one knows of the other, the other might not, having a weaker weighting factor as a bi-directional interaction, e.g. a facto of 0.5.

The upper right diagram in FIG. 11 shows a second type of interaction 4100 illustrating a frequency type interaction. The interaction frequency is measured as the frequency of data exchange between the employee account 21′ and the actor accounts 11′, 12′, 13′. The value of the interaction frequency may be represented as ratio of data exchange per day, week, month, quarter or year, as mentioned earlier. In the frequency type examples shown in FIG. 11, timelines define whether the interaction is active, fading or cold. The interaction 4101 between employee account 21″ and actor account 13′ (indicated as long dashed line) is active, i.e. based on email exchanges within the past six months. The interaction 4102 between employee account 21′ and actor account 12′ (indicated as short, dashed line) is fading, i.e. based on no email exchanges within the past six months but seven months back falling into an overall twelve-month range. The interaction 4103 between employee account 21′ and actor account 11′ (indicated as dotted line) is cold, i.e. based on no email exchanges within the past 12 months. Accordingly, the weighting factor for the fading interaction 4102 is stronger than for the cold interaction 4103 but weaker than for the active interaction 4101. For example, the weighting factor for a cold interaction is 0.2, the weighting factor for a fading interaction is 0.6, and the weighting factor for an active interaction is 1.0.

The lower left diagram in FIG. 11 shows a third type of interaction 4200 illustrating an ownership type interaction. The ownership type is measured by counting the number of employee accounts related to the same actor account. The values of this ownership parameter are for example “exclusive” and “shared”. This determines whether an employee has an exclusive relationship with an external contact or whether other employees are connected with that contact, too. In the example of FIG. 11, all the interaction with the external actor accounts 11′, 12′, 13′ are exclusive ownership interactions with the employee account 21′. Accordingly, the employee data related to the employee account 21′ has a strong weighting factor, because it serves as an important knot in the electronic link network being the only link to the external actors having the actor accounts 11′, 12′, 13′. For example, the weighting factor for a shared interaction is 0.7, and the weighting factor for an exclusive interaction is 1.0.

The lower right diagram in FIG. 11 shows a fourth type of interaction 4300 illustrating a number type interaction. The number of interactions between the employee and an external actor is measured as the number of data exchanges between the employee account 21′ and the external actor accounts 11′, 12′, 13′. For example, it can be counted as the overall number of interactions, or as the number interactions within one email thread, i.e. a number of data exchange interactions within a conversation. As mentioned earlier, the parameter value may be indicated as a simple interaction count number or a category, like category 1 for 1-5 data exchange interactions, category 2 for 6-10 data exchange interactions, category 3 for 11-20 data exchange interactions, etc. The higher the interaction number, respectively the category, the stronger is the link intensity and the weighing factor is assigned accordingly. In FIG. 11, the weighting of the employee-based electronic links is interactions indicated by the diameter of the “bubble” or circle representing the external actor accounts. The interaction 4301 between the employee account 21′ and the actor account 11′ has a high interaction count number, which results in a large circle. The interaction 4302 between the employee account 21′ and the actor account 12′ has a low interaction count number, which results in a small circle. The interaction 4303 between the employee account 21 and the actor account 13′ has an intermediate interaction count number, which results in a medium size circle. For example, the weighting factor for a category 1 link is 0.3, the weighting factor for a category 2 link is 0.7, and the weighting factor for a category 3 link is 0.9.

Other types of interactions defined by their interaction parameter values and their weighting factors can be displayed in a similar fashion, for example a number of link branches and user function type interaction.

With reference to the example employee-based electronic links described in FIGS. 6 and 7, evaluating considerations for establishing weighting factors may be as follows. There is no differentiation between TO: and CC: email recipients. Taking the example of FIG. 6 above: Employee (Tobias) sends an email to externals Mike (TO:) and Jack (CC:) and internal Prasad (CC:). A uni-directional interaction indicating a one-way relationship, a.k.a. knows off relationship, is established. TO: and CC: are not treated differently in the process of establishing a relationship. However, Prasad doesn't establish a relationship to both external actors as only recipient of email from internal. Taking the example of FIG. 6 below: Mike responds to Tobias, Jack, and Prasad. Mike establishes a relationship with Prasad a.k.a. knows off and confirms a bi-directional relationship with Tobias. Here again, TO: or CC: are weighted equally. Meeting interactions count equally to establishing a relationship. Establishing a relationship via a meeting is established once the organizer receives a meeting acceptance. Non-acceptance is not contributing to establishing a relationship, but still is based on a uni-directional interaction. Of course, other assessment strategies for quantifying a link strength, respectively weighting factors, are possible.

FIG. 12 shows a diagram illustrating steps of an example electronic method for automated detection and assessment of employee-based electronic links according to the invention using MIME extracts as data exchange source. The example method includes a step of capturing additional information data related to interaction parameters of an employee-based electronic link, actor parameters of an external actor and/or an actor grouping. The additional information data can be added to the link data or actor data. For example, the access unit 16 retrieves information data related to actor parameters extracted by the accumulation device 5 and adds the information data to the actor data 111, 121, 131 or creates new actor data set in case an actor data set does not exist yet. To do so the electronic system comprises an extended network logic, such as an extended extraction algorithm 51. The basic interaction data pool can be extended with additional information data of any other data source, e.g. LinkedIn contacts. Technically the system will identify interaction parameter values of interactions with external contacts non-existent in the core network (base layers 1-3) and add information data regarding external actor parameters from other sources. Taking LinkedIn as an example data store, an employee may not interact with an external via email but have additional connects from LinkedIn that may contribute to the network view. This will require the consent of the employee. Technically the core network logic will remain the same, there will be another filter added to the trigger table (see Expanding Network Dimensions).

FIG. 12 illustrates a summarized diagram of the data mining and control steps of the electronic method describing the core logic to compose network views from MIME extracts. The method sets boundaries for the data capturing and data mining to determine the electronic link network for a time period of interest and network participants of interest. In a step “External Domain Exclusion” the interaction data pool will be limited to extracting maximum 48 months of past interaction data. The data restriction is for example determined by the extracting algorithm 51. The focus of the algorithm is to exclude all externals with “rcomext.com” domains used for externals engaged by employees. In addition, all other contractors identified via Active Directory can be excluded. In a step “Whitelisted Domain Exclusions” whitelisted domains such as private or personal email domains such as Gmail, will be excluded from the interaction data pool. The data exclusion is for example controlled by the extracting algorithm 51. In a step “Contact Deduplication & Structuring” external actor account de-duplication is performed based on the interaction parameter of a unique email ID. This can be accomplished by the extracting algorithm 51, or by the repository unit 8.

As shown in FIG. 12 for an electronic data exchange interaction in form of an emailing interaction and a meeting arrangement interaction, in an automatic data capturing step 400 the trigger module 3 automatically captures employee data comprising employee parameter values for employee parameters identifying at least one employee account involved in the interaction, and automatically captures link data comprising interaction parameter values for interaction parameters characterizing the employee-based electronic link between the employee account and the external actor account. In a data extraction step 410, the accumulation device 5 extracts external actor data comprising actor parameter values for actor parameters from the link data. In the example, the data extraction step 410 includes:

Step 4101 Extract External Contacts from Email Data: Identify email address from “From, TO and CC fields”
Step 4102 Extracting from Meetings Data: Identify email address from “Organizer and Attendees”
Step 4104 Enrich from Contacts Registry: Lookup matching emails value and enrich name value from: First Name and Last Name
Step 4105 Extract Domains value: Extract domain from email address e.g. “ibm.com” and enrich actor data, i.e. contact record

In more detail, the automatic data capturing step 400 and the data extraction step 410 of the example method illustrated in FIG. 12, include the following individual steps:
1. Steps 4101, 4102: Extraction of email addresses from the MIME extract (Emails and Meetings). External email addresses are taken from external senders (From) of emails and meetings (Organizer) plus from external recipients of emails (TO & CC) and of meeting attendees (REQUIRED & OPTIONAL).
2. Step 4103 Once the external email addresses are extracted, the de-duplication process is initiated, i.e. every email address is unique. First & Last Name of the external actor account/contact are provided by MIME as well.
3. Step 4105: This step extracts the domain from each email address e.g. hans_muster@firm.com to extract firm.com.
4. Step 4106: The link network module 4 assigns a unique actor identification code (ID) to every new external actor account/contact created. One contact record can only have one email address and one first & last name assigned.
   Output: Basic Output to be presented in a tabular format with column filters and select count:

| First | Last | Email | | Contact |
|---|---|---|---|---|
| Name | Name | Address | Domain | ID |
| John | Dhoo | john.dhoo@ibm.com | ibm.com | CID12345 |

The link data includes actor parameters of the external actor account interacting with the employee account. The actor account is identified by the actor parameters representing the actor first name “John”, the actor last name “Dhoo”, the actor email address “john.dhoo@ibm.com”, the actor email domain “ibm.com” and the actor contact identification “CID12345”. This set of actor data establishes a foundation or standard external contact record, as summarized in FIG. 13.

The newly extracted contact record is composed as shown in FIG. 13. The contact record object represents the foundation of all subsequent use cases for modelling the electronic link network. It covers all external email addresses that have interacted (emails and meetings) with employees over a given period.

Once the contact record, respectively the actor account, with the actor data is established, the electronic method continues with the data mining and transfer control process for modelling the electronic link network, i.e. connecting the dots of employee accounts and actor accounts. Each external actor data set is enriched by interaction parameter values specifying the employee-based electronic link, respectively the interactions between the employee accounts and the external actor account.

The anchor for interaction data extraction is the external contact's email address, e.g. extracted in steps 4101, 4102. FIG. 14 illustrates the extraction of interaction parameter values from the MIME interaction data, i.e. the link data, as mentioned before. The data extraction step 410 comprises the following steps to enrich the actor data set of FIG. 13:

Step 4107 Extract interaction time parameter value from Inbound Emails: Extract first and last inbound interaction dates
Step 4108 Extract email exchange count from Inbound Emails: Extract every inbound interaction data point incl. first and last dates
Step 4108′ Extract email exchange count from Outbound Emails: Extract every outbound interaction data point incl. first and last dates
Step 4109 Extract meetings count from Meetings: Extract every meeting data point including first, last, and future meeting dates

FIG. 15 shows the actor data set of the external actor account of FIG. 13 extended by the link parameter values extracted from the link data as discussed for FIG. 14. In this example, the actor parameter data set of the standard external actor account/contact record is extended by parameter values for the interaction parameters indicating a date of a first/last meeting interaction, a total meeting count, a date of a first/last email exchange interaction and a total inbound/outbound email exchange count. In a weighting step 420 the weighting algorithm 95 automatically assigns weighting factors to the interaction parameter values of the contact record defining an enriched contact record based on weighted link data. For example, weighting factors as described with the help of 110 can be used to establish a weighted contact record, respectively actor account. In summary, the extended contact record including the weighted link data includes insights from the electronic interactions of an employee with the external actor.

It is emphasized that the data mining engine of the link network module 4 dynamically updates any employee data and link data, which serve as the interaction data pool for deriving the actor data and weighted link data for the employee accounts and the external actor accounts. Any changes in the relationship network can reflected in real time.

In a modelling step 430 for modelling the output electronic link network the network modelling algorithm 95 and the machine learning structure 96 model an electronic link network based on selected specific employee parameters and/or actor parameter values by automatically aggregating the employee-based electronic links associated with the selected specific parameter values according to their weighting factor. The modelled electronic link network is provided as an output signal of the electronic system 1. Thus, the output electronic link network technically represents the strength of the employee-based electronic links of the network and reflects the intensity and importance of relationships between employees and external actors.

As mentioned earlier, the electronic system 1 can be realized as an online platform or computer application accessible for example via the employees' units 21, 22, 23. The electronic method can by controlled by operating the electronic system 1 for example via input devices, like keyboards and touchscreens, connected to the employees' units 21, 22, 23. In a parameter value selection step 4301 a user of the electronic system selects specific employee parameters and/or actor parameter values as the basis for the network modelling. The system 1, for example, selects an employee account, an actor account or a group of accounts of interest and the network is modelled around the accounts of interest.

In one example variant of the electronic system and method of the invention, the electronic system may be connected to or embedded in an Application Visualization, like Flagship, which serves as an interface between the user and the electronic system. The Application Visualization may be operated via an internet browser like Explorer, Google Chrome, Safari, etc. A monitor of a computer may serve as the visualization unit 18 for displaying pages of the Application Visualization and the electronic link network presentation. A front-end of the Application Visualization may be designed as follows:

FIG. 16 shows the Explorer Page-Home: The user can select specific employee parameter values and/or actor parameter values for example from a pull down menu field 4310 or enter a parameter value of interest in a selection field. For example, the user can enter employee name, external contact name or company name.

FIG. 17 shows the Explorer Page-Search: The user selects employee-based parameter “name” and the parameter value “Peter Mueller”, wherein Peter Mueller for example is a Sales Representative employee.

FIGS. 18 and 19 show Explorer Pages-Result: displaying electronic link network presentations according to selected parameter values. The Application Visualization presents the output electronic link network as a single employee account centered network based on a “One to Many” format.

FIG. 18 shows the Explorer Page-Result for a “One to Many” network format-Network Display (Relationships). Besides the parameter value “Peter Mueller”, a parameter value of the interaction parameter “relationship type” is selected to be “bi-lateral” in the relationship type selection area 4312. The output electronic link network of FIG. 18 represents the relationship network of Peter Mueller for bi-directional relationships only. Further, parameter values of the interaction parameter “interaction frequency” are selected to be “active”, “fading” and “cold” in the interaction frequency selection area 4314. That means the interaction frequency parameter value is chosen not to be a limitation for the network modelling. Parameter values of the interaction parameter “ownership” are selected to be “exclusive” and “shared” in the ownership selection area 4316. That means the ownership parameter value is chosen not to be a limitation for the network modelling. In a time frame selection area 4318, a time frame value “last 2 years” is selected, which limits the electronic link network to employee-based electronic links including data exchange interaction within the last 2 years.

The output electronic link network is depicted as a visual representation having the employee account of interest “Peter Mueller” in the center, circular fields for different actor accounts having an employee-based electronic link with the employee account of “Peter Mueller”, and concentrical orbits around the center for actor accounts with differing “interaction frequency” parameter values. An inner orbit 5000 with a small first diameter includes actor accounts with an “interaction frequency” parameter value “active”. An intermediate orbit 5010 with a second diameter, larger than the first diameter, includes actor accounts with an “interaction frequency” parameter value “fading”. An outer orbit 5020 with a third diameter, larger than the second diameter, includes actor accounts with an “interaction frequency” parameter value “cold”. The actor accounts can be shown in a color code corresponding to their “interaction frequency” parameter value, wherein active accounts are green, fading accounts are yellow and cold accounts are grey. The diameter of the circular fields representing the actor accounts corresponds to a link parameter “number of interactions”. Accounts with an employee-based electronic link of less than 50 interactions have a circular field 5030 with a first small diameter, accounts with 50-100 interactions have a circular field 5040 with a second diameter, larger than the first diameter, and accounts with more than 100 interactions have a circular field 5050 with a third diameter, larger than the second diameter. The output electronic link network is a multi-layer presentation of the relationships of Peter Mueller and a plurality of external actors. Strong relationships can easily be identified due to the visual coding of the employee-based electronic links and their weighting in the network. The output electronic link network can be updated automatically and customized to meet particular interests.

The Relationship network of Peter Mueller shown in FIG. 18 can be expanded with another “orbit” ring indicating unidirectional relationships, as shown in FIG. 19. In contrast to the first output electronic link network of FIG. 18, the output electronic link network displayed in FIG. 19 the interaction parameter values for the parameter “relationship type” is selected to be “bi-lateral” and “inbound”. Accordingly, a fourth orbit 5060 is added to the electronic link network presentation of FIG. 18, which has a fourth diameter larger than the third diameter. This outermost orbit 5060 encircles all actor accounts comprising unidirectional data exchange with the employee account of Peter Mueller in form of inbound email or meeting data exchange.

FIGS. 18 and 19 show Explorer Pages-Result: displaying electronic link network presentations according to selected parameter values. The Application Visualization presents the output electronic link network as a single employee account centered network based on a “One to Many” format.

FIGS. 20 and 21 show an internet browser page “Result” of the Application Visualization presenting a third output electronic link network as a group centered network based on a “One to Many Company” format. For the “One to Many Company” format, the value matching logic 171 of the grouping unit 17 aggregates actor data of several actors or employee data of several employee accounts comprising an identical actor or employee-based parameter value as an external actor grouping data set or an employee grouping data set. In the present example the output electronic link network is based on identical domain parameter values. The value matching logic 171 groups all actor accounts characterized by an identical domain as a company grouping. That is for example all actor account comprising the domain value “bankofzurich.ch”, “intel.com”, “microsoft.com”, “apple.com”, “nike.com”, etc. The domain parameter indicates the company an external actor is associated with. Accordingly, the relationship network of Peter Mueller can be grouped by companies, as shown in FIG. 20. A user can switch between the “One to Many” format and the “One to Many Company” format by activating or deactivating a grouping field 4320.

As shown in FIG. 20, the third output electronic link network in the “One to Many Company” format depicts company groupings as circular fields 6000 that have employee-based electronic links with the selected employee account “Peter Mueller”. The size of the diameter of the grouping fields 6000 indicates a link strength of the employee-based electronic links between the employee account and the actor accounts of the company. The grouping “Bank of Zurich” is selected as being of most interest in located in the center of the network presentation. Alternatively, the company grouping having the strongest employee-based electronic links with the selected employee account can be located in the center of the presentation. The actor accounts of this grouping are shown as the circular fields 5030, 5040 and 5050 as for the “One to Many” format introduced in FIGS. 18 and 19. On the right side of the network presentation an actor account field 6010 lists all actor accounts of a selected company grouping.

FIG. 21 shows the output electronic link network presentation of FIG. 20, wherein a specific actor account 6001 is selected. In the present example this is the actor account comprising the name parameter value “Jacob Weber”. In the actor account field 6010, a list of interaction parameter values for this actor account is shown, such as the ownership parameter with the parameter value “shared”, the interaction frequency parameter with the parameter value “active”, the interaction number parameter with the parameter value “182”, etc. The actor account field 6010 provides a summary of the relationship insights automatically extracted from the employee data and the interaction data by the electronic system.

FIG. 22 shows an internet browser page “Result” of the Application Visualization presenting a fourth output electronic link network based on a “Many to Many Company” format, which illustrates employee-based electronic links 7000 between a plurality of employee accounts and a plurality of actor accounts 7020. The “Many to Many Company” format is depicted as table presentation listing actor accounts 7020 of an actor grouping “Bank of Zurich” versus one or more employee accounts and connecting the actor accounts with employee account by depicting connections according to weighted link data. In the example of FIG. 22, employee accounts of the same job function parameter value are grouped, e.g. a sales group employee accounts 7010, marketing group employee accounts 7012, legal group employee accounts 7014, 7016, etc., and listed on the left side. Other employee-based parameters may be selected for groupings. On the right side all actor accounts 7020 comprising employee-based electronic links with the employee accounts are listed. The employee-based electronic links 7000 are depicted as connecting lines between the employee accounts and actor accounts. The connecting lines may display the link strength by the color coding for the interaction frequency parameter value as discussed for the network presentation of FIG. 19. Of course, other interaction parameters can be selected as the basis for indicating the link strength as discussed earlier.

The electronic system 1 can also be assessed by an Application Visualization (Outlook Plugin). In addition to the Visualization Applications (browsers), there can e.g. be an Outlook plugin to contextualize network data with a user's inbox. Whenever an email of an external actor is selected via the inbox, the network insights will be displayed in the plugin. This allows users to retrieve relevant insights without changing the system.

Finally, FIG. 23 illustrates the electronic method for automated detection and assessment of employee-based electronic links for providing an electronic link network model. As explained for FIGS. 1, 2 and 12, the electronic system 1 comprises a plurality of employees' units 21, 22, 23 associated to employee accounts 21′, 22′, 23″ that interact with a plurality of external units 11, 12, 13 associated to external actor accounts 11′, 12′, 13′. The electronic interactions in form of data exchange establish employee-based electronic links 213′, 223′, 233′, 243′. According to the automatic data capturing step 400, the trigger module 3 monitors the data exchange and automatically captures employee data 211, 221, 231 from plurality of employees' units 21, 22, 23 and link data 213, 223, 233, 243 characterizing the interactions of the employee-based electronic links between the plurality of employees' units 21, 22, 23 and the plurality of external units 11, 12, 13. The captured employee data and link data are transferred as an input signal 35 to the link network module 4. Additional information data, such as the external information data 214, 224, 234, may be captured in an add data step 405, for example by the access unit 16, from the active directory 81, or another information data library. In the data extraction step 410, external actor data 111, 121, 131 characterizing external actor accounts is identified and extracted from the link data by the extracting algorithm 51 of the accumulation device 5, and stored in the repository unit 8 for further processing. The data extraction step 410 for example includes the steps of extracting external contacts from email data 4101, extracting from meetings data 4102, de-duplication process 4103, enrichment from contact registry 4104, extracting domain value 4105, assigning identification code to actor account 4106, extracting interaction time parameter value 4107, extracting email exchange count 4108, 4108′, and extracting meetings count 4109.

In the assigning weighting factor step 420, the weighting factors are determined by the weighting unit 5 and automatically assigned to one or more of the captured parameter values of the employee data and/or link data and weighted link data is provided for the employee-based electronic links. In the electronic link network modelling step 430, the network modelling algorithm 73 of the trigger table 7 models an electronic link network based on selected specific employee parameter values and/or interaction parameter values by automatically aggregating the employee-based electronic links associated with the selected specific parameters according to their weighting factor. The specific employee parameter values and/or interaction parameter values are selected in the parameter value selection step 4301 using the parameter filters 71, 72, for example by using pull down menu field 4310, relationship type selection area 4312, interaction frequency selection area 4314, ownership selection area 4316, and/or time frame selection area 4318 of the Visualization application. In an identical value grouping step 4302, using the grouping field 4320 for selecting a grouping parameter value, employee accounts and/or actor accounts having identical employee-based parameter values or interaction parameter values can be grouped together. The electronic link network is provided as an output electronic link network in form of an output signal 75 to the visualization unit 18. In a visualization step 440, the output electronic link network is presented by the visualization unit 18 for example according to a “One to Many” format, “One to Many Company” format, or “Many to Many Company” format as described for FIGS. 18-22.

The electronic system and method of the present invention to provides automated detection and impact weighting of employee-based electronic links established electronic data exchange interaction flow. They derive an electronic link network structure for representing a real world customer relationship network. More specific, the electronic system and method transform data interaction information into a qualified customer network, extract and reflect topics and trends discussed within the customer network, and act as technical distribution mechanism for sharing customer information across employees. They extract and distribute customer insights along a dynamic relationship network and automatically update the electronic link network. The electronic system and method are flexibly adaptable and customizable to differing assessment emphasis, easily configurable to react to changing characteristics of customer relationships, simple to be integrated in existing customer relationship management systems, and able to provide a current relationship network presentation in real-time.

### LIST OF REFERENCE NUMERALS

1 Automated detection and impact weighting system
   11, 12, 13 External actor/external actor's unit
   11′, 12′, 13′ External actor account
      111, 121, 131 Actor data
   15 Digital network
   16 Access unit
   17 Grouping unit
      171 Value matching logic
      172 Grouping data set
   18 Visualization unit
   19 Conversation integration logic
   21, 22, 23 Employee/employee's unit
   21′, 22′, 23′ Employee account
   211, 221, 231 Employee data
   211′ Additional employee data
   212, 222, 232 Electronic network structure of employees
   213, 223, 233, 243 Employee-based electronic link data
      2131, 2132, 2133 Data exchange interaction
   213′, 223′, 233′, 243′ Employee-based electronic link
   214, 224, 234 Stored external information data
   215, 225, 235 Messaging tool
3 Trigger module
   31, 32, 33 Capturing devices
   35 Input signal
4 Data mining and transfer control module
   400 Automatic data capturing step
   405 Add data step
   410 Data extraction step
      4101 Extract external contacts from email data
      4102 Extract from meetings data
      4103 De-duplication process
      4104 Enrich from contact registry
      4105 Extract domain value
      4106 Assign identification code to actor account
      4107 Extract interaction time parameter value
      4108, 4108′ Extract email exchange count
      4109 Extract meetings count
   420 Assign weighting factor
   430 Electronic link network modelling
      4301 Parameter value selection
      4302 Identical value grouping
      4310 Pull down menu field
      4312 Relationship type selection area
      4314 Interaction frequency selection area
      4316 Ownership selection area
      4318 Time frame selection area
      4320 Grouping field
   440 Visualization step
5 Accumulation device
   50 Data extraction algorithm
      51 First interaction contribution
      52 Second interaction contribution
      53 Third interaction contribution
      54 Fourth interaction contribution
6 Data store
7 Trigger table with link segmentation and measuring parameters
   71, 72 Parameter filters
   73 Network modelling algorithm
   75 Output signal
      711, 712, 713, 714 Selection parameters
      721, 722, 723, 724 Segmentation parameters
8 Repository unit
   81 Active directory
9 Weighting unit
   91, 92, 93, 94 Weighting factors
      913, 923, 933, 943 weighted link data
   95 Weighting algorithm
   96 Machine learning structure
1000, 1002, 1004, 1006, 1008 Box
2000, 2002, 2004, 2006, 2008 Data mining and transfer blocks
2010 Mail group
2014, 2014′, 2014″ Electronic email data exchange interaction
2016, 2016′, 2016″ Electronic meeting data exchange interaction
2020 Employee unidirectional outbound email interaction
2021 Employee unidirectional inbound email interaction
2022 Employee unidirectional inbound meeting interaction
2023 Employee unidirectional outbound meeting interaction
3000, 3002, 3004 First, second, third electronic link network view
4000, 4100, 4200, 4300 First, second, third, fourth interaction type
   4001 Outgoing unidirectional interaction
   4002 Incoming unidirectional interaction
   4003 Outgoing unidirectional interaction
   4101, 4102, 4103 Active, fading, cold interaction
   4301, 4302, 4303 High, low, intermediate count interaction
5000 Inner orbit
5010 Intermediate orbit
5020 Outer orbit
5030 First diameter circular field
5040 Second diameter circular field
5050 Third diameter circular field
5060 Outermost orbit
6000 Company grouping circular field
6001 Specific actor account
6010 Actor account field
7000 Employee-based electronic links
7010 Sales group employee accounts
7012 Marketing group employee accounts
7014 Legal group employee accounts
7016 Finance group employee accounts
7020 Actor accounts

1. An electronic system for automated detection and assessment of employee-based electronic links of at least one employee to external actors electronically interacting with the at least one employee wherein the electronic system is based on automated interaction data mining and impact weighting of the employee-based electronic links, the electronic system comprising:
processing circuitry configured to implement
a trigger module with a plurality of capturing devices connectable to at least one employee's unit for automatically capturing employee data comprising employee-based parameter values for one or more employee-based parameters identifying at least one electronic employee account associated to the at least one employee or employee's unit and for capturing link data comprising interaction parameter values for one or more interaction parameters characterizing electronic interactions of the employee-based electronic links,
a trigger table providing an electronic link network based on selected employee parameter values or selected interaction parameter values, and a link network module for data mining and transfer control connected to the trigger module and the trigger table, wherein the link network module at least comprises or is connectable to
an accumulation device connected to the trigger module automatically receiving the employee data and the link data and to a repository unit, the accumulation device comprising a data extraction algorithm extracting external actor data comprising actor parameter values of actor parameters included in the link data, and storing the employee data, the link data and the external actor data in the repository unit, and
a weighting unit connected to the accumulation device or the repository unit and comprising a weighting algorithm automatically assigning weighting factors to one or more of the captured interaction parameter values or to the employee-based electronic links, and providing weighted link data for the employee-based electronic links,
wherein the link strength and the weighting factor are determined by measuring the employee and interaction parameters and capturing additional external link parameter data related to the interactions and links, and the weighting algorithm comprising a machine learning structure assessing the link strength contribution of a data exchange interaction based on the measured employee and interaction parameters and additional external link parameter data,
wherein a weighting factor correlates to a link strength of the parameter value of the weighted interaction parameter, defining the contribution of an interaction to each employee-based electronic link and the contribution of an employee-based electronic link to the overall electronic link network, and
wherein the trigger table comprises parameter filters for selecting specific employee parameter values or interaction parameter values based on different types of interactions defined by their interaction parameter values and their weighting factors, and
a network modelling algorithm modelling the employee-based electronic links associated with the selected specific parameters according to their weighting factor as the output electronic link network, wherein data sources are added dynamically expanding network dimensions of the electronic link network.

2. The electronic system according to claim 1, wherein an employee-based electronic link is established by electronic data exchange between the at least one employee's unit and at least one digital unit of the external actor interacting with the at least one employee's unit in form of electronic messaging data transaction exchanged via a digital network.

3. The electronic system according to claim 1, wherein the processing circuitry is further configured to implement an access unit connected or connectable to a data store hosting information data related to actor parameters of an external actor or an actor grouping and to the accumulation device or the repository unit, wherein the access unit retrieves information data related to actor parameters extracted by the accumulation device.

4. The electronic system according to claim 1, wherein the link network module comprises a grouping unit included in or connected to the accumulation device or connected to the repository unit, the grouping unit comprising a value matching logic aggregating actor data of several external actors or employee data of several employee accounts comprising an identical actor or employee-based parameter value as an external actor grouping data set or an employee grouping data set.

5. The electronic system according to claim 1, wherein the value matching logic is a domain matching logic identifying identical values of a domain parameter in several external actor data sets and grouping the associated several external actor data sets as a domain grouping data set.

6. The electronic system according to claim 1, wherein the weighting algorithm comprises a machine learning structure assessing a link strength contribution of a data exchange interaction based on existing or historical employee data or actor data associated to an employee account.

7. The electronic system according to claim 1, wherein the employee data includes employee-based parameters of the employee account representing a name, an email address, an email domain or an employee function, wherein employee-based parameter values are detected by the capturing devices.

8. The electronic system according to claim 1, wherein the link data includes interaction parameters representing an interaction frequency, interaction number, interaction time or time frame, interaction classification, number of link branches, link identification, link ranking or interaction type, wherein interaction parameter values are detected by the capturing devices.

9. The electronic system according to claim 1, wherein the link data includes actor parameters of an external electronic actor account interacting with the electronic employee account, wherein the actor parameters represent an actor name, an actor email address, an actor email domain or an actor function, wherein actor parameter values are detected by the capturing devices.

10. The electronic system according to claim 1, wherein a weighting factor corresponds to a categorization indicating a link strength of a parameter value of an interaction parameter, wherein a categorization is defined as interaction time period categories, interaction frequency categories, interaction type categories, employee function categories, actor function categories or interaction classification categories.

11. The electronic system according to claim 1, wherein the link network module comprises a data mining engine dynamically triggering the trigger module to capture the employee data and the link data and/or the access unit to capture information data in case of a new interaction in the employee-based link.

12. The electronic system according to claim 1, wherein the processing circuitry is further configured to implement a visualization unit for depicting the output electronic link network as a visual representation of concentrical orbits their diameter depending on a weighting factor of a selected interaction parameter or as a field for one or more selected actors parameter values, the diameter of the field depending on the weighting factor of the selected interaction parameter of the selected actors parameter values.

13. The electronic system according to claim 1, wherein the processing circuitry is further configured to implement a visualization unit for depicting the output electronic link network as table presentation listing actor accounts of an actor grouping versus one or more employee accounts and connecting actor accounts with employee account by depicting employee-based electronic links according to weighted link data.

14. An electronic method for automated detection and assessment of employee-based electronic links of at least one employee to external actors based on automated digital interaction data mining for extracting an electronic output link network by processing circuitry of an electronic system, the electronic method comprising
automatically capturing employee data from at least one employee's unit, wherein the employee data comprises employee parameter values for employee parameters identifying at least one employee account associated to a unit, and link data comprising interaction parameter values for interaction parameters characterizing an employee-based electronic link between the employee account and the external actor,
extracting external actor data comprising actor parameter values for actor parameters from the link data,
automatically assigning a weighting factor to one or more of the captured parameter values of the employee data or to the employee-based electronic links, providing weighted link data for the employee-based electronic links,
determining the link strength and the weighting factor by measuring the employee and interaction parameters and capturing additional external link parameter data related to the interactions and links,
assessing the link strength contribution of a data exchange interaction based on the measured employee and interaction parameters and additional external link parameter data by a machine learning structure of the weighting algorithm,
wherein a weighting factor correlates to the link strength of the parameter value of the weighted interaction parameter, defining the contribution of an interaction to each employee-based electronic link and the contribution of an employee-based electronic link to the overall electronic link network, and
wherein the trigger table comprises parameter filters for selecting specific employee parameter values or interaction parameter values based on different types of interactions defined by their interaction parameter values and their weighting factors,
modelling an electronic link network based on selected specific employee parameter values or interaction parameter values by automatically aggregating the employee-based electronic links associated with the selected specific parameters according to their weighting factor, wherein data sources are added dynamically expanding network dimensions of the electronic link network, and
providing the electronic link network as an output electronic link network.

15. The electronic method according to claim 14, wherein the electronic output link network is switched between a single employee account centered network and a group centered network based on employee or actor groupings, that are based on identical employee-based parameter values or interaction parameter values, wherein switching is initiated by selecting ether a specific grouping parameter value or an individual employee parameter value or actor parameter value.
